(19) United States
(12) Patent Application Publication
(10) Pub. No.: US 2001/0002481 A1
(43) Pub. Date: May 31, 2001

(54) DATA ACCESS UNIT AND METHOD THEREFOR

(76) Inventors: SAKAE ITOH, TOKYO (JP); TATSUYA SAKAI, KANAGAWA (JP); MASAYUKI MURAKAMI, KANAGAWA (JP); TSUTOMU NUMATA, KANAGAWA (JP)

Correspondence Address: BURNS DOANE SWECKER & MATHIS L L P, POST OFFICE BOX 1404, ALEXANDRIA, VA, 22313-1404, US

(21) Appl. No.: 09/030,829

(22) Filed: Feb. 26, 1998

(30) Foreign Application Priority Data
Mar. 21, 1997 (JP) 68791/97

(51) Int. Cl. G06F 12/00

(52) U.S. Cl. 711/167; 711/112; 711/102; 711/104

(57) ABSTRACT

A data access unit is provided with: clock synchronizing means for operating a hard disk controller and a microcomputer unit in synchronization with a clock signal; and control means whereby plural data input/output operations between the hard disk controller and the microcomputer unit, based on a single-access request command issued from a CPU of the latter, are each performed continuously, discretely, or in a combination thereof for an arbitrary access time according to the response status created in accordance with the access condition of a resource managed by the hard disk controller.

### BACKGROUND OF THE INVENTION

1. Field of the Invention

The present invention relates to a data access unit through which a microcomputer accesses data of peripheral devices and a data access method therefor.

2. Description of the Prior Art

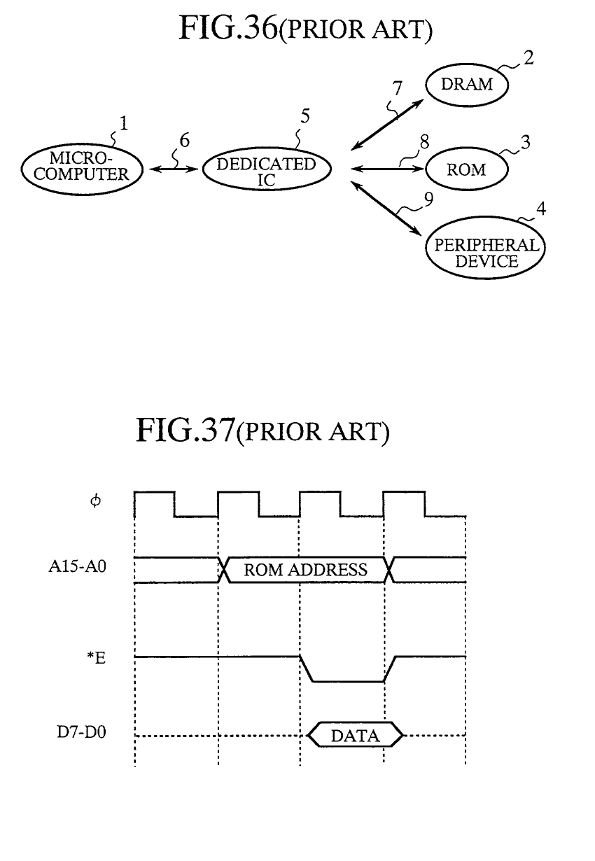

FIG. 36 is a diagram showing the general configuration of a conventional data access unit. In FIG. 36, reference numeral 1 denotes a microcomputer. Numeral 2 denotes a dynamic random access memory (hereinafter referred to as a DRAM). Numeral 3 denotes a read only memory (hereinafter referred to as a ROM). Numeral 4 denotes a peripheral device. Numeral 5 denotes a dedicated integrated circuit (hereinafter referred to as an IC) which, upon receiving read addresses A15 to A0, shown in FIG. 37, from the microcomputer 1, reads and sends thereto data D7 to D0, shown in FIG. 37, from the specified addresses A15 to A0. Numerals 6 to 9 denote a bus, respectively.

Next, the operation of the access unit of the above configuration will be described.

To begin with, when the microcomputer 1 needs to read therein the data D7 to D0 stored in the ROM 3, it outputs the read addresses A15 to A0 (addresses where the data D7 to D0 are stored) to the dedicated IC 5 in synchronization with a clock signal φ as shown in FIG. 37.

Upon receiving the read addresses A15 to A0 from the microcomputer 1, the dedicated IC 5 reads therein the data D7 to D0 from the ROM 3 as described below in concrete terms.

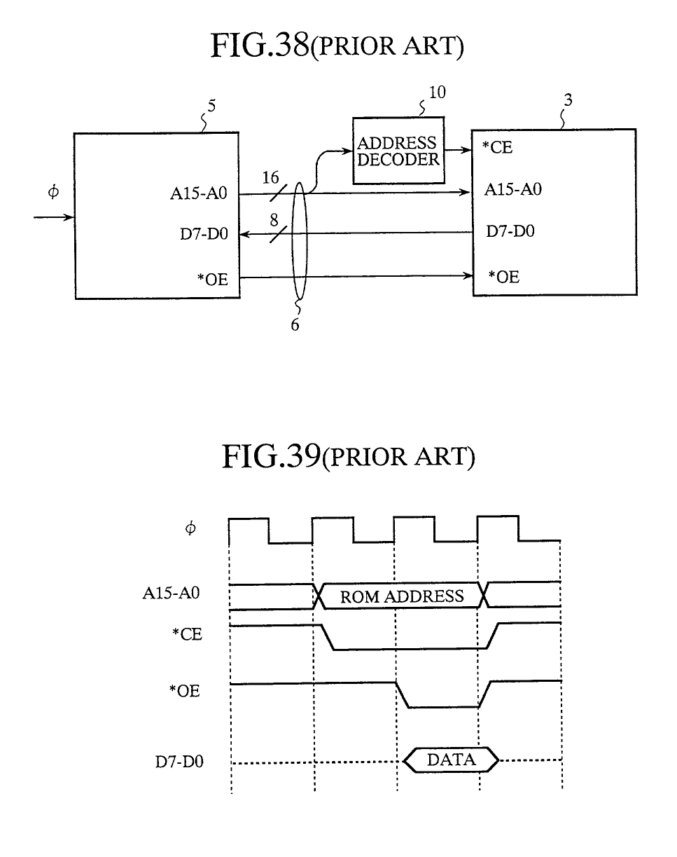

The dedicated IC 5 and the ROM 3 are interconnected via the bus 6 as depicted in FIGS. 36 and 38. When the read addresses A15 to A0 are output from the dedicated IC 5 to an address decoder 10, the signal level at a chip enable input terminal *CE of the ROM 3 goes low as shown in FIG. 39, enabling the ROM 3 to transfer the data D7 to D0 stored at the specified addresses A15 to A0.

And when the signal level at an *OE input terminal of the ROM 3 connected to an *OE output terminal of the dedicated IC 5 goes low (under the control of the dedicated IC 5), the ROM 3 outputs the data D7 to D0 onto a data bus of the bus 6.

Then the dedicated IC 5 reads therein the data D7 to D0 from the data bus of the bus 6.

The data readout method of FIG. 39 requires designation of the read addresses A15 to A0 upon each transfer of one byte of data, and hence it adopts a scheme of transferring one-byte data with two clock pulses of the clock signal φ. Rapid data readout could also be achieved by using, as the ROM 3, a ROM capable of implementing a data readout method called “burst access” (a method for rapidly reading data stored in a sequence of contiguous addresses on the ROM).

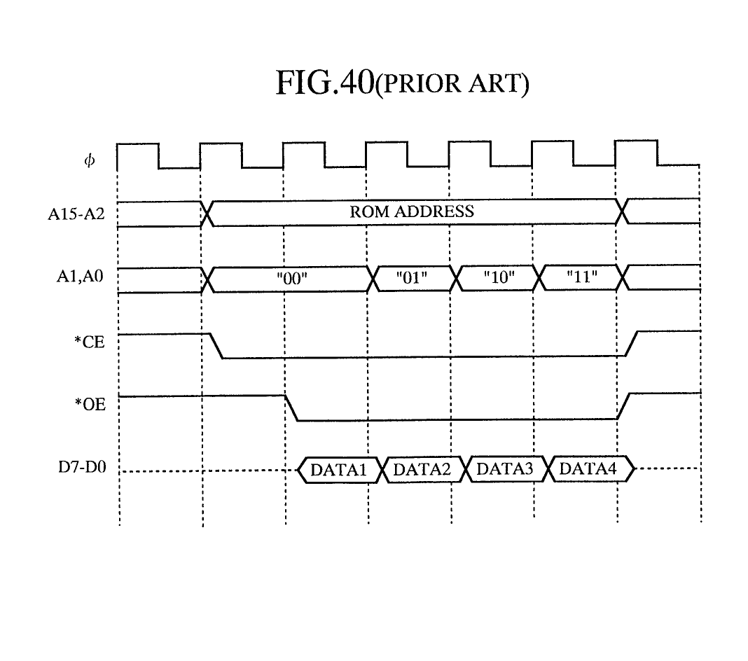

For example, as shown in FIG. 40, in case of reading out data of four bytes having same values in addresses A15 to A2 but respectively different values in addresses A1 and A0, the data of four bytes can be transferred in succession by fixing the values stored in the addresses A15 to A2 and properly changing the values stored in the addresses A1 and A0 alone. With the use of this data readout method, four-byte data can be transferred with five clock pulses of the clock signal φ (whereas the ordinary data readout method of FIG. 39 requires eight clock pulses (=2 clock pulses×4) for the transfer of four-byte data).

When the dedicated IC 5 has thus reads therein the data D7 to D0 from the ROM 3, the microcomputer 1 makes low the signal level at an *E input terminal (not shown) of the dedicated IC 5 connected to an *E output terminal (not shown) of the microcomputer 1, causing the dedicated IC 5 to provide the data D7 to D0 read therein onto a data bus of the bus 6. (Since the microcomputer recognizes that the dedicated IC 5 reads therein one-byte data with two clock pulses of the clock signal φ by the ordinary data readout method of FIG. 39, the microcomputer 1 makes the signal level concerned low upon input of the next clock after outputting the read addresses A15 to A0.)

Thus the microcomputer 1 reads therein the data D7 to D0 from the data bus of the bus 6 and completes a sequence of processing steps. In case of reading data of two or more bytes, the above operation needs to be repeated accordingly.

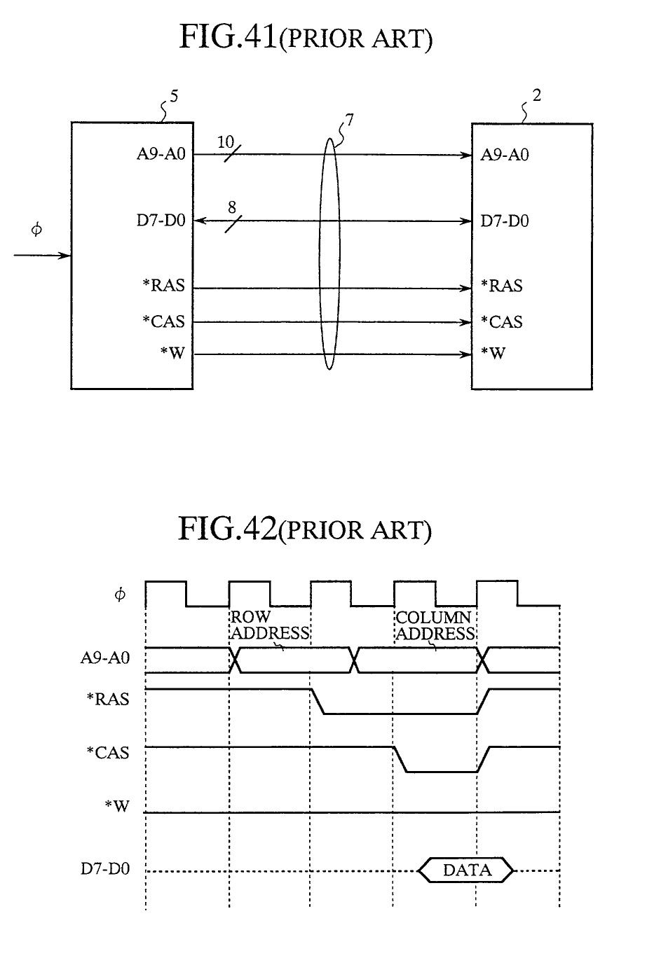

Incidentally, the same procedure as mentioned above is also used when the microcomputer 1 reads data from the DRAM 2 or the peripheral device 4. As shown in FIGS. 41 and 42, the data transfer system between the dedicated IC 5 and the DRAM 2 designates addresses in two groups of row and column addresses unlike the data transfer system between the dedicated IC 5 and the ROM 3.

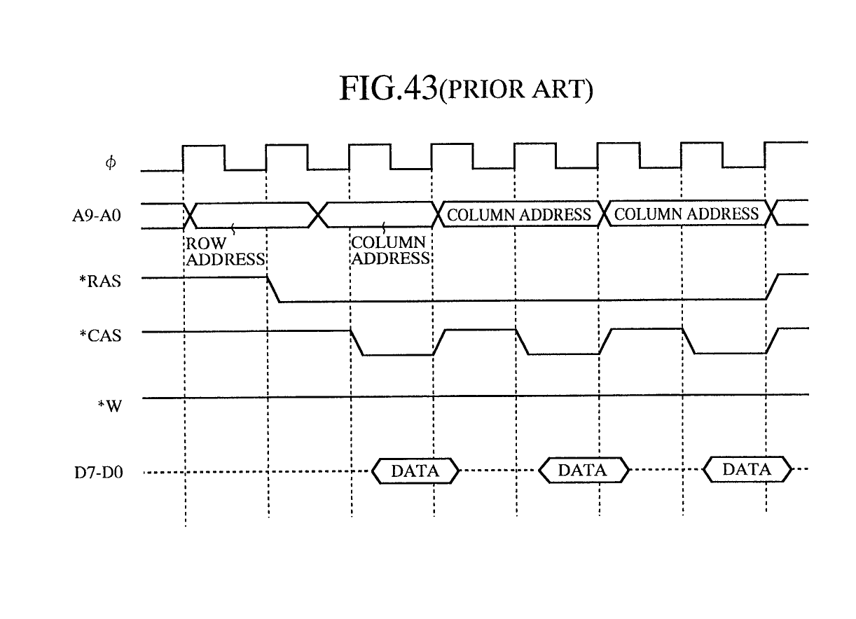

Further, quick data readout can be done by using, as the DRAM 2, a DRAM capable of implementing a data readout method called a “fast page mode” (a method for rapidly reading data stored in a sequence of contiguous addresses on the DRAM) as depicted in FIG. 43. With this data readout method, only the column addresses are designated in second and subsequent data accesses and no row address designation is needed. Hence, the number of clocks necessary for data access can be reduced.

Next, a description will be given in more detail of the conventional data access method for use in the case where a microcomputer unit (hereinafter referred to as an MCU) for control of a hard disc drive (hereinafter referred to as an HDD) is connected to a hard disc controller (hereinafter referred to an HDC).

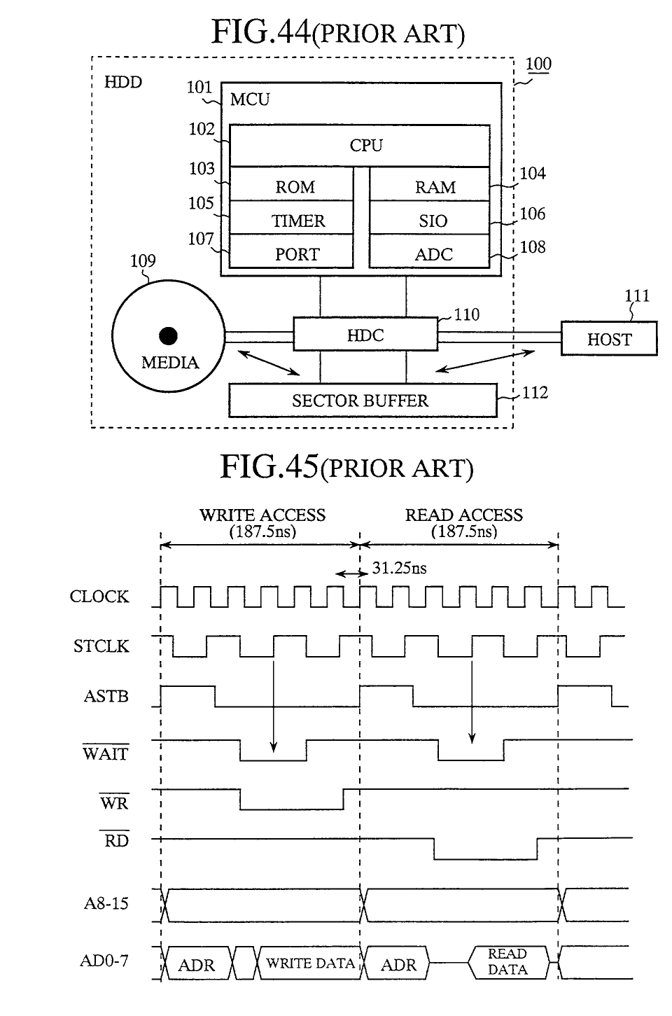

FIG. 44 is a block diagram showing the configuration of the HDD. In FIG. 44, reference numeral 100 denotes generally the HDD. Reference numeral 101 denotes the MCU. Numeral 102 denotes a central processing unit (hereinafter referred to as a CPU). Numeral 103 denotes a ROM. Numeral 104 denotes a random access memory (hereinafter referred to as a RAM). Numeral 105 denotes a timer. Numeral 106 denotes a serial communication unit. Numeral 107 denotes a universal port. Numeral 108 denotes an analog-to-digital converter (hereinafter referred to as an ADC). Numeral 109 denotes a hard disc. Numeral 110 denotes the HDC. Numeral 111 denotes a host computer. Numeral 112 denotes a sector buffer that is used as a user buffer for data transfer between the hard disc 109 and the host computer 111.

Now, the operation of the HDD 100 will be described.

Conventionally, the HDD 100 is controlled by using the MCU 101 which has the CPU 102, the ROM 103, the RAM 104, the timer 105, the serial communication unit 106, the universal port 107 and the ADC 108 integrated on one chip as shown in FIG. 44. The MCU 101 is also used with devices other than the HDD 100 and employs a general-purpose signal interface therefor. When the MCU 101 is connected to the HDC 110, an efficient data transfer is difficult because of the general-purpose signal interface.

FIG. 45 is a timing chart showing an example of an external interface signal of a general purpose MCU of 32 MHz. CLOCK is an original clock, which is generated by an oscillator incorporated in the MCU 101 or supplied from the HDC 110 or similar external device. STCLK is a standard clock that usually has a half frequency of that of the original clock, and the MCU 101 operates in synchronization with this clock. AD0 to 7 are signal buses for use in common to low-order addresses and data, and addresses are always output from the MCU 101. Since the MCU 101 outputs an address strobe signal ASTB together with an address, the HDC 110 uses the address strobe signal ASTB to hold therein the low-order address. When the MCU 101 effects a write operation, it provides a write signal WR and write data and the HDC 110 uses the write signal WR to load therein data from the bus. When the MCU 101 effects a read operation, the bus is placed in a high-impedance state and the MCU 101 outputs a read signal RD. The HDC 110 responds to the read signal RD to send the data to the MCU 101, which reads therein the data at the point of time when the read signal RD rises up.

A wait signal WAIT is output from the HDC 110 when the access period needs to be extended because of slow processing at the HDC 110 side. The MCU 101 checks this signal by the leading edge on the standard clock STCLK and, if it is at the low level, defers completion of the access.

A8 to 15 are high-order address dedicated signals, which are maintained during access. With the use of the high-order address dedicated signals A8 to 15, it is possible to address a total of 16 bits (64 Kbytes), including the low-order address held in the HDC 110.

The MCU 101 and the HDC 110 could be operated in synchronization with the same clock by sending to the former, as the original clock CLOCK, a clock that is used in the latter. In many cases, however, the standard clock STCLK delays largely behind the original clock CLOCK and timing therefor is not definitely defined—this makes synchronous or concurrent transmission and reception of various interface signals difficult between the MCU 101 and HDC 110 at frequencies above 32 MHz. It is necessary, therefore, to synchronize the signal from the MCU 101 with an internal clock of the HDC 110 before use or hasten the application of the output signal from the HDC 110 to the MCU 101.

Moreover, the HDD 110 requires a large storage area that can freely be read and written, other than the RAM of a several-Kbyte capacity loaded in the MCU 101. To meet this requirement without raising the device cost, there has been proposed a technique that allows also the MCU 101 to have access to the sector buffer 112 used as a user buffer for data transfer between the hard disc 109 and the host computer 111.

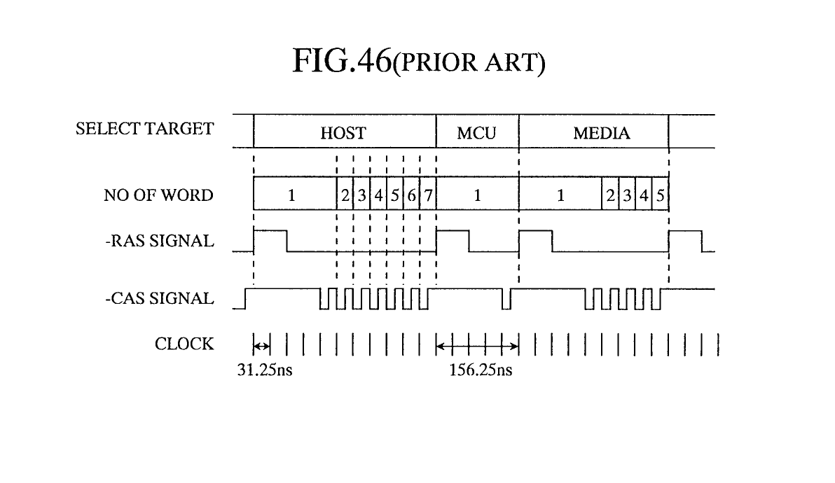

Usually, a DRAM is employed as the sector buffer 112. To increase the efficiency of data transfer, the access to the sector buffer 112 is time-shared and each access is performed in a page mode (FAST PAGE: FP, or EXTENDED DATA OUT: EDO) of the DRAM. In the page mode the first access (a first word) takes much time but accesses to the second and subsequent words in the same page can be processed continuously in a short time. FP and EDO differ mainly in the timing for this continuous transfer but hardly differ in terms of costs. The future trend seems to be the utilization of EDO by virtue of its high-speed property. In FIG. 46 there is shown an example of the EDO-DRAM access from HDC 110 (access time 70 ns and 32 MHz clock control).

A signal RAS indicates the page address sending timing of the DRAM and a page address is loaded in the DRAM at the trailing edge of the RAS signal. At the trailing edge of a signal CAS an in-page address is provided to the DRAM. When the memory is written, the HDC 110 sends data at the trailing edge of the CAS signal together with the address therefor and the DRAM loads therein the data at this point in time. When the memory is read, the DRAM outputs data at the next trailing edge of the CAS signal and the HDC 110 loads therein the data. The last word for the page access is loaded at the trailing edge of the RAS signal because no trailing edge of the CAS signal is present at that point.

The sharing of time is based on a contention control theory for management of the sector buffer 112. The sector buffer 112 is controlled so that data transfer requests from the host computer, media and the MCU are services on a fixed-priority basis. In such a system as mentioned above, the RAM is secured in terms of capacity, but the MCU is interposed between the media requiring a high data transfer rate (bandwidth) and the host computer. Since data is transferred on a word-by-word basis, no sufficient data is supplied to the MCU and no efficient data transfer can be accomplished by the general-purpose MCU interface.

One possible technique that has been proposed to solve this problem is a system disclosed in U.S. Pat. No. 5,465,343. In this U.S. patent it is disclosed that the MCU band can be increased by placing an instruction prefetch register (claims 1 and 3) and a cache buffer (claims 8, 9 and 17) in the HDC and making access to the DRAM in the page mode.

With the conventional data access unit and data access method described above, the speeding up of data transfer between the dedicated IC 5 and the ROM 3 can be achieved by the burst access or similar data read method. Since only single data can be transferred in two cycles between the microcomputer 1 and the dedicated IC 5, however, the microcomputer 1 cannot read data at high speed. For rapid readout of data by the microcomputer 1, it is necessary to extend the bus width of the bus 6 or speed up the operation of the bus 6—this will inevitably raise the cost of the entire system.

Further, signals for data access and their accessing time differ in data accessing objects, and the data read time also differs accordingly. Therefore, the data read timing of the microcomputer 1 needs to be changed each time a user changes the data-accessing object. This impairs the general versatility of the microcomputer 1.

In the HDD 100 in FIG. 44 it is necessary, for operating the MCU 101 and the HDC 110 in synchronization with the clock, to once synchronize the signal from the MCU 101 with the internal clock of the HDC 110 prior to use therein or hasten the timing for applying the output signal from the HDC 110 to the MCU 101. Accordingly, the data transfer is particularly time-consuming in the HDD 100.

The interface of the MCU 101 is set in view of the general versatility of directly connecting thereto a memory and is predicated on one access, presenting a problem that the determination of the read/write signal and data output timing is slow.

Besides, in the system that has an instruction prefetch register and a cache buffer in the HDC and accesses the DRAM in the page mode, (1) a complicated cache control theory such as a hit check theory is needed and the hardware size readily increases. (2) A cache of plural-word capacity is used to allow access to the sector buffer in the page mode. But since the request of the MCU to the sector buffer is a mixture of a program code fetch and a data access accompanying program execution, addresses are likely to become discontinuous, diminishing the probability of referring to an address succeeding the immediately preceding reference address. On this account, even if access is made in the page mode through utilization of a cache control mechanism of one system, an extra-read-out portion is likely to become of no use. To avoid this, plural systems of cache control mechanisms are needed and a complex theory is needed accordingly. (3) To allow access to the sector buffer in the page mode for MCU write processing, it is necessary to effect complex control of once storing data in the cache and making access to the sector buffer after checking the address continuity.

### SUMMARY OF THE INVENTION

It is therefore an object of the present invention to provide a low-cost data access unit and method that allow a microcomputer to rapidly access data without impairment of its general versatility.

Another object of the present invention is to provide a data access unit and method which solve the HDD control problem of the conventional MCU interface and implement high efficiency, rapid access between the MCU and the HDC and among the MCU, HDC and a sector buffer without involving complex control in the HDC.

To attain the above objects, according to a first aspect of the present invention, there is provided a data access unit which comprises: a hard disk controller; a microcomputer unit connected thereto; clock synchronizing means for operating the hard disk controller and the microcomputer unit in synchronization with a clock signal; control means whereby plural data input/output operations between the hard disk controller and microcomputer unit, based on a single-access request command issued from the CPU of the latter, are each performed continuously, discretely, or in a combination thereof for an arbitrary access time according to the response status created in accordance with the access condition of the resource managed by the hard disk controller. This data access unit permits speeding up of the data input/output between the microcomputer unit and the hard disk controller without impairing the general versatility of the former.

According to a second aspect of the present invention, there is provided a data access unit which comprises: a microcomputer unit transmitting a data access mode designating signal and a data access address; receive means for receiving the data access mode designating signal and the data access address transmitted from said microcomputer; recognize means for recognizing a data access mode based on the data access mode designating signal received by said receive means; data access means for accessing the data access address received by said receiving means; and send means for sending to said microcomputer an acknowledge signal indicating the end of data accessing of said data access means when said data access means has completed the accessing of the data access address, and for transmitting a data to or from said microcomputer from or to the data access address in the data access mode recognized by said recognize means. This data access unit permits speeding up of the microcomputer unit's accessing operation of data without impairing the general versatility of the former and increasing its production cost.

According to a third aspect of the present invention, there is provided a data access method in which: a disk media controller and a microcomputer connected thereto are actuated in synchronization with a clock; and when a CPU of the microcomputer issues a single-access request command, each data input/output operation between the microcomputer and the controller is performed continuously, discretely, or in a combination thereof for an arbitrary access time according to the response status created in accordance with the access condition of the controller's managing resources. With this method, it is possible to speed up the data input/output between the microcomputer unit and the disk media controller without impairing the general versatility of the former.

### BRIEF DESCRIPTION OF THE INVENTION

Other objects, features and advantages of the present invention will become more apparent from the following description taken in conjunction with the accompanying drawings, in which:

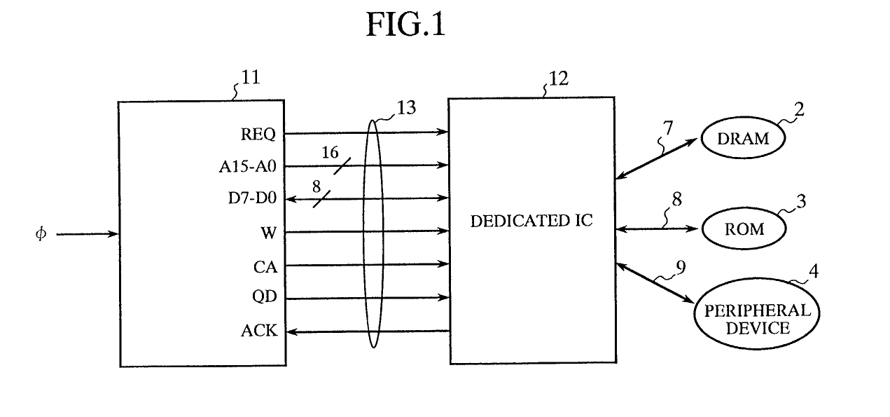

FIG. 1 is a block diagram illustrating a data access unit according to a first embodiment of the present invention;

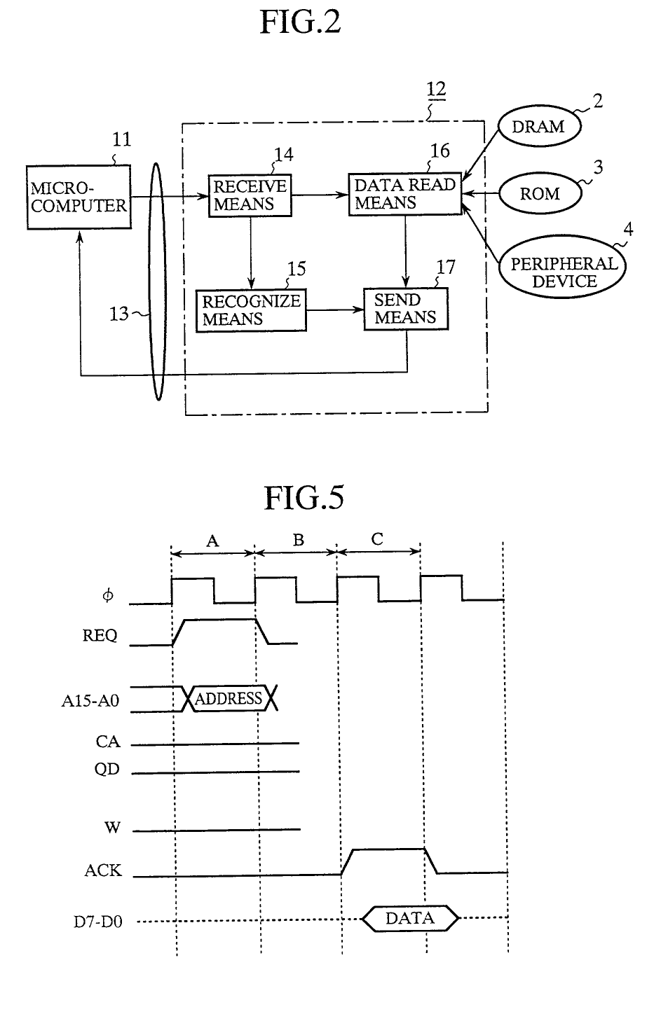

FIG. 2 is a functional block diagram for explaining the function of the data access unit according to the first embodiment of the present invention;

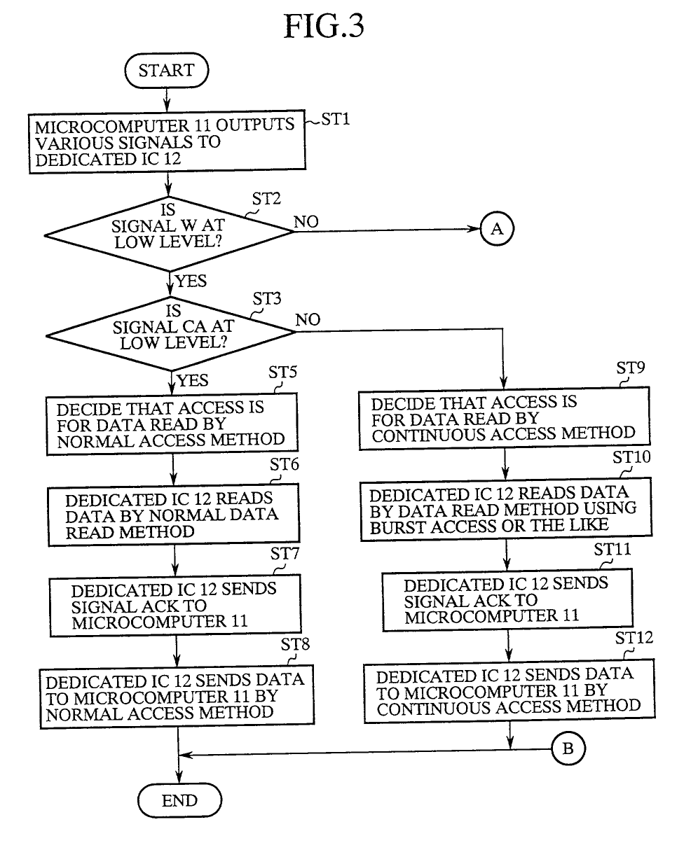

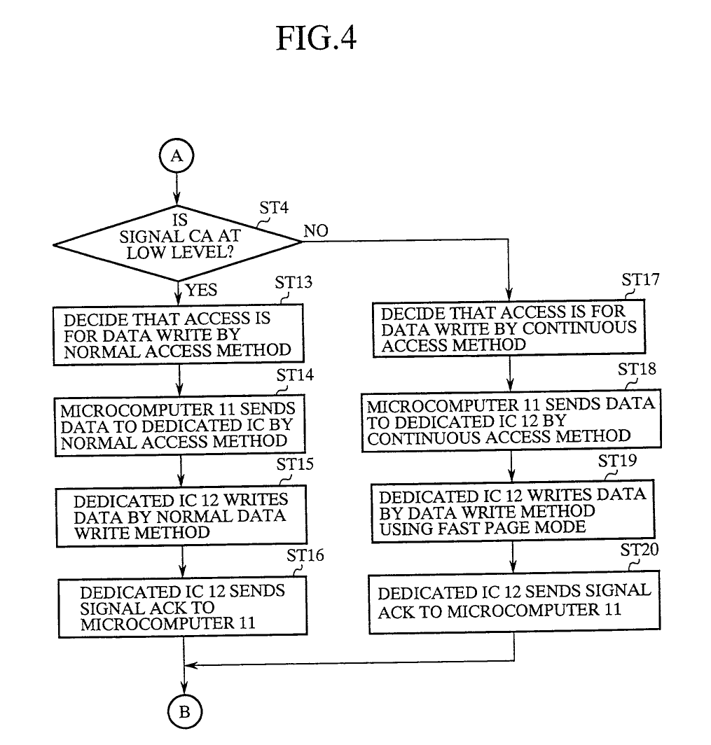

FIGS. 3 and 4 constitute a flowchart showing a data access method for the data access units according to the first embodiment and a second embodiment of the present invention;

FIG. 5 is a timing chart for explaining data read processing by an ordinary access method;

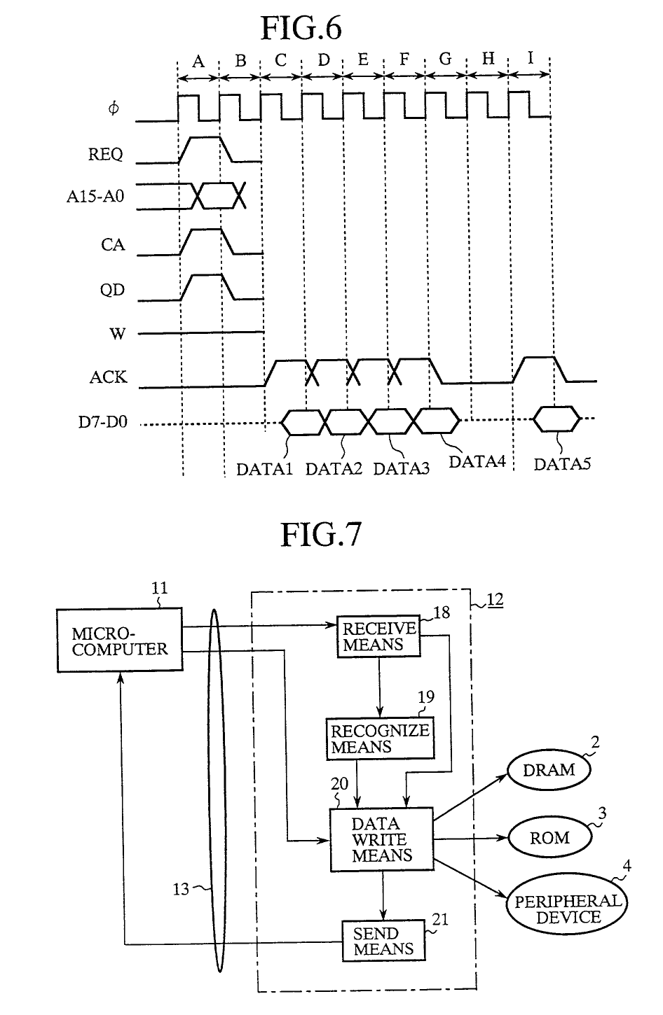

FIG. 6 is a timing chart for explaining data read processing by a continuous access method;

FIG. 7 is a functional block diagram of the data access unit according to the second embodiment of the present invention;

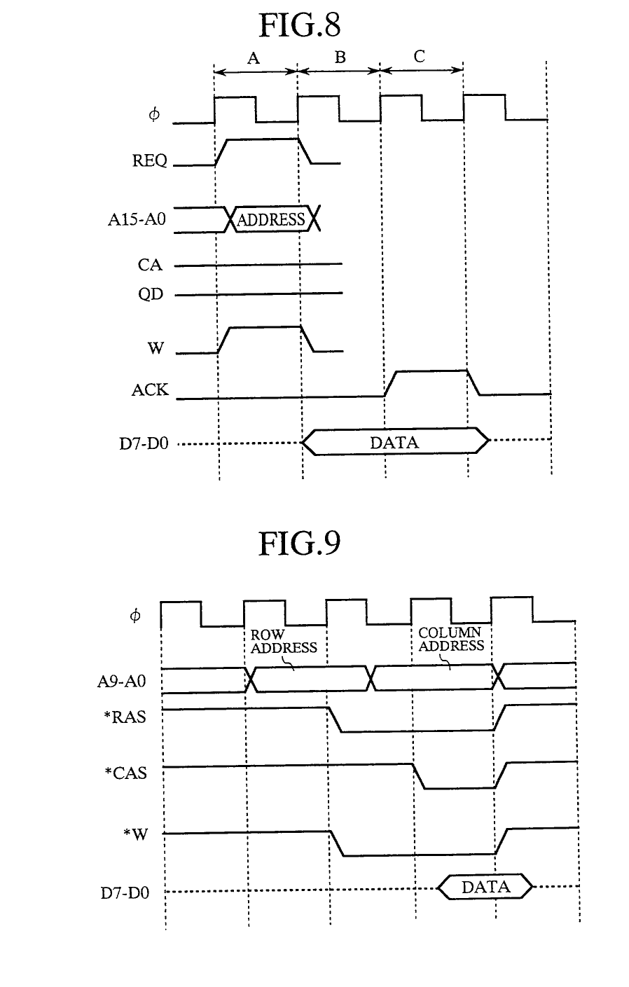

FIG. 8 is a timing chart for explaining data write processing by the ordinary access scheme;

FIG. 9 is a timing chart showing a common data write method;

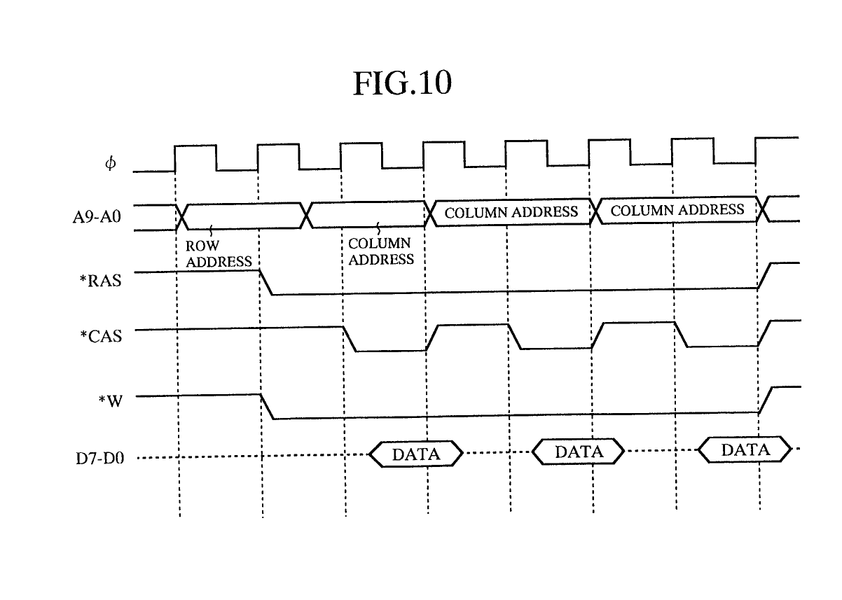

FIG. 10 is a timing chart showing a data write method using a fast page mode;

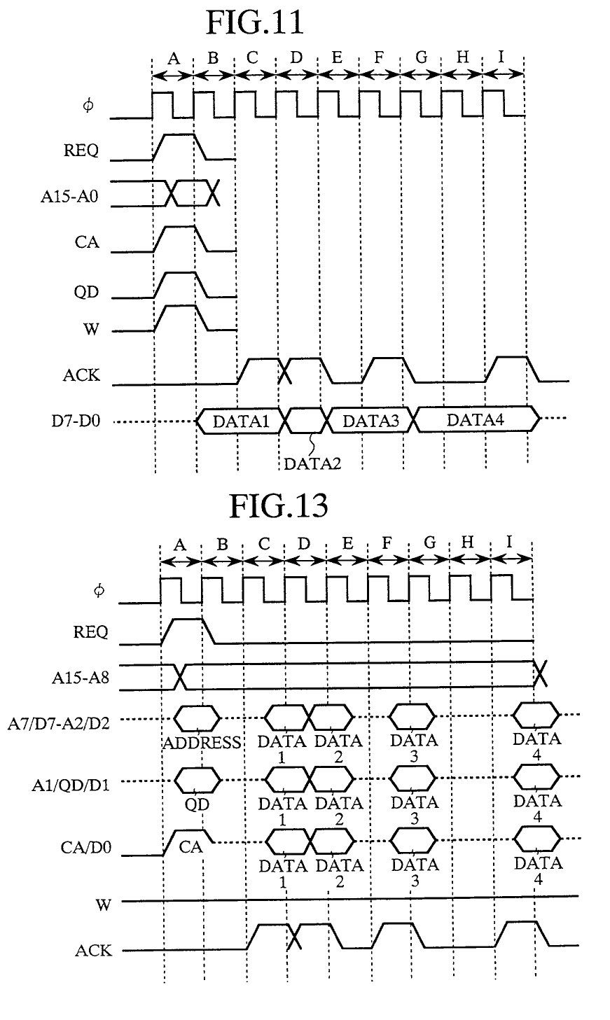

FIG. 11 is a timing chart for explaining data write processing by the continuous access method;

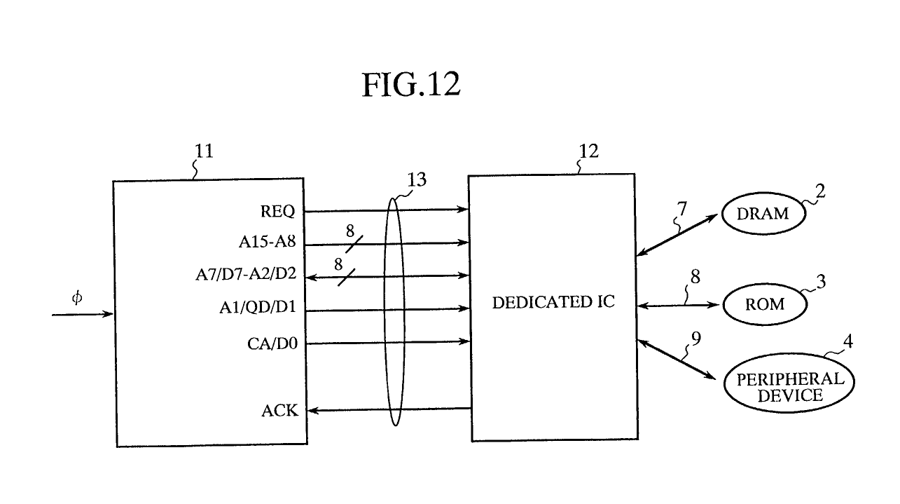

FIG. 12 is a block diagram illustrating a data access unit according to a third embodiment of the present invention;

FIG. 13 is a timing chart for explaining data read processing by the continuous access method;

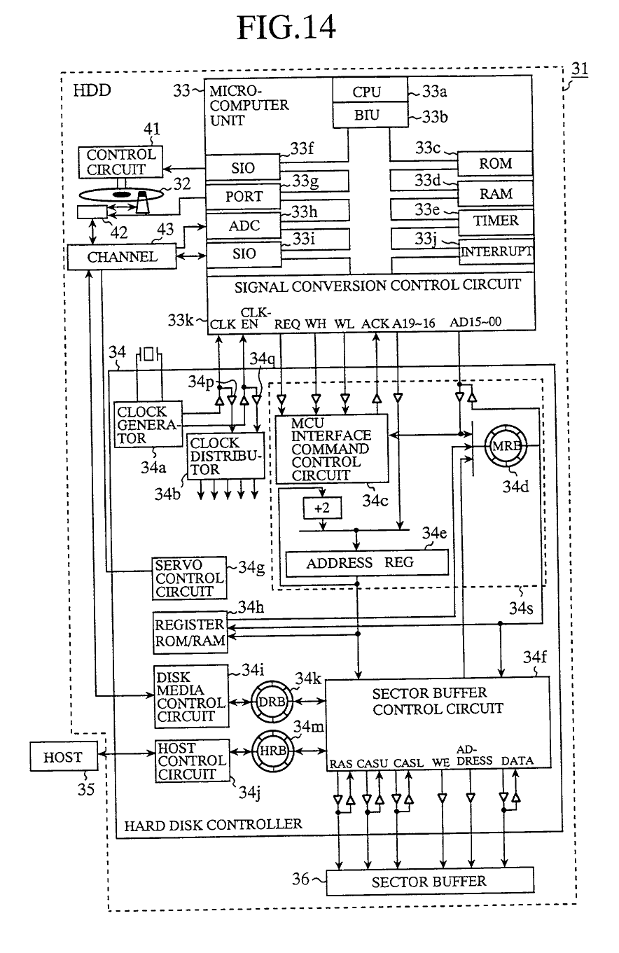

FIG. 14 is a block diagram illustrating the configuration of an HDD in a fourth embodiment of the present invention;

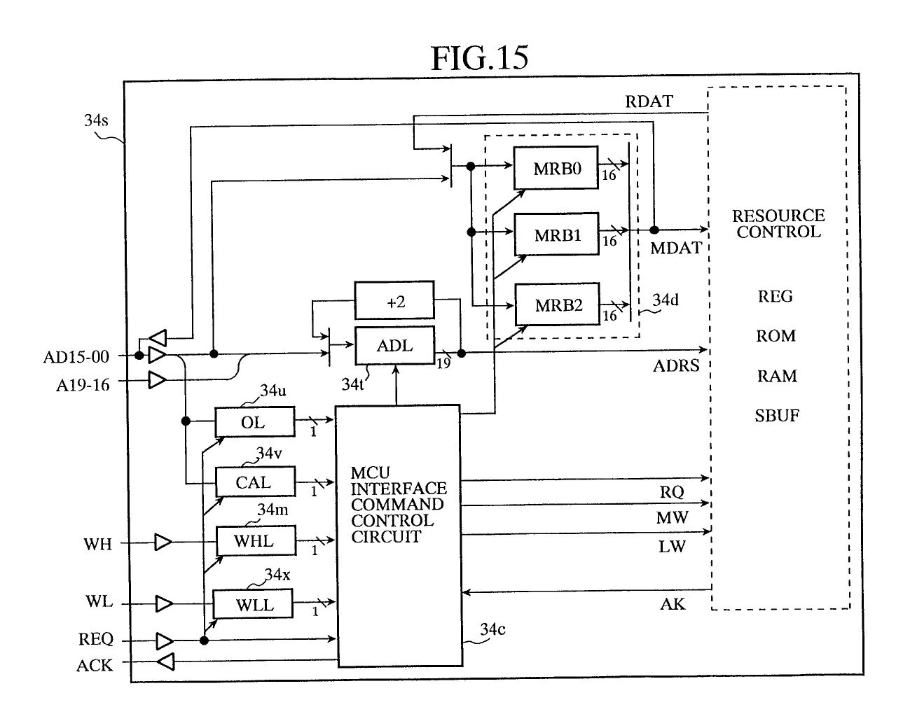

FIG. 15 is a block diagram illustrating the configuration of an MCU interface control circuit of the HDD in the fourth embodiment of the present invention;

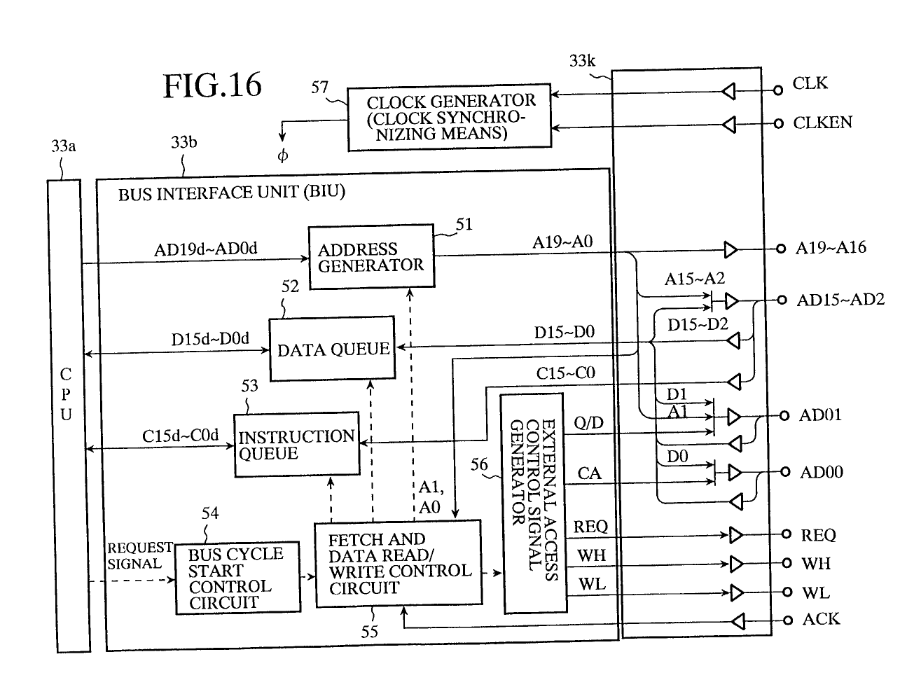

FIG. 16 is a block diagram illustrating the configurations of a CPU, a bus interface unit (hereinafter referred to as a BIU) and an external interface control circuit of an MCU in the HDD of the fourth embodiment of the present invention;

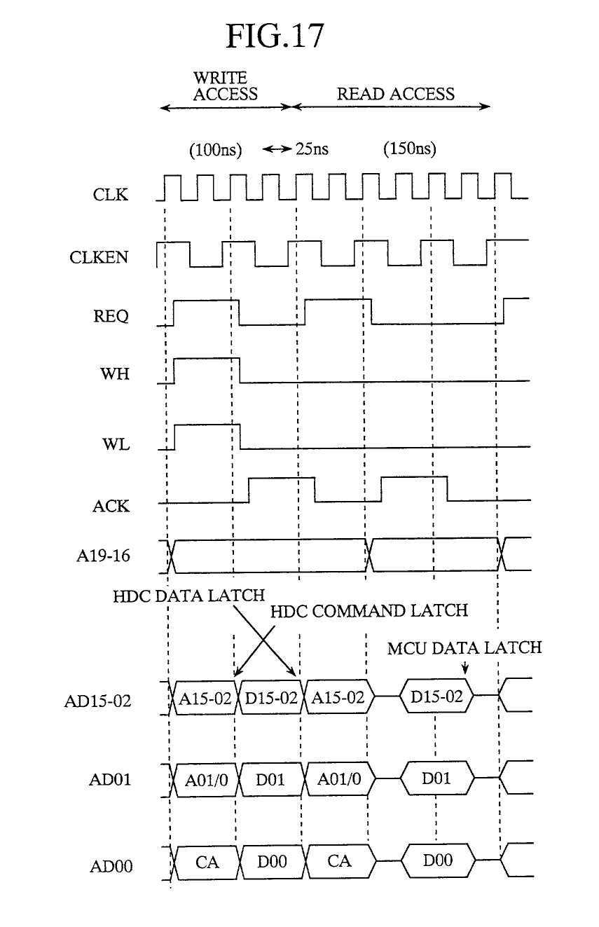

FIG. 17 is a timing chart showing an example of one-word access of an interface signal between the MCU and the HDC;

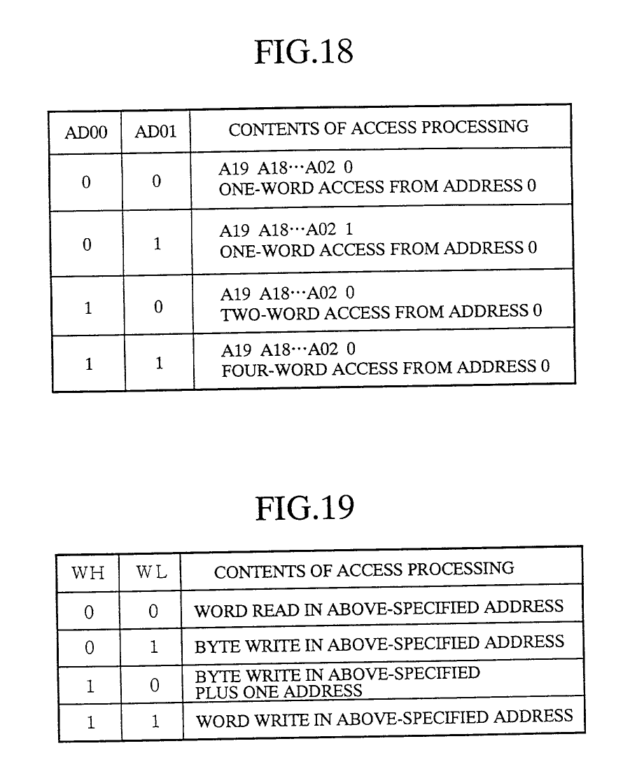

FIG. 18 is an explanatory diagram showing the contents of the access that are performed in response to a continuous access signal and command information such as the number of times the continuous access is to be made;

FIG. 19 is an explanatory diagram showing the contents of access that are performed in response to a high-order/low-order byte write identification signal;

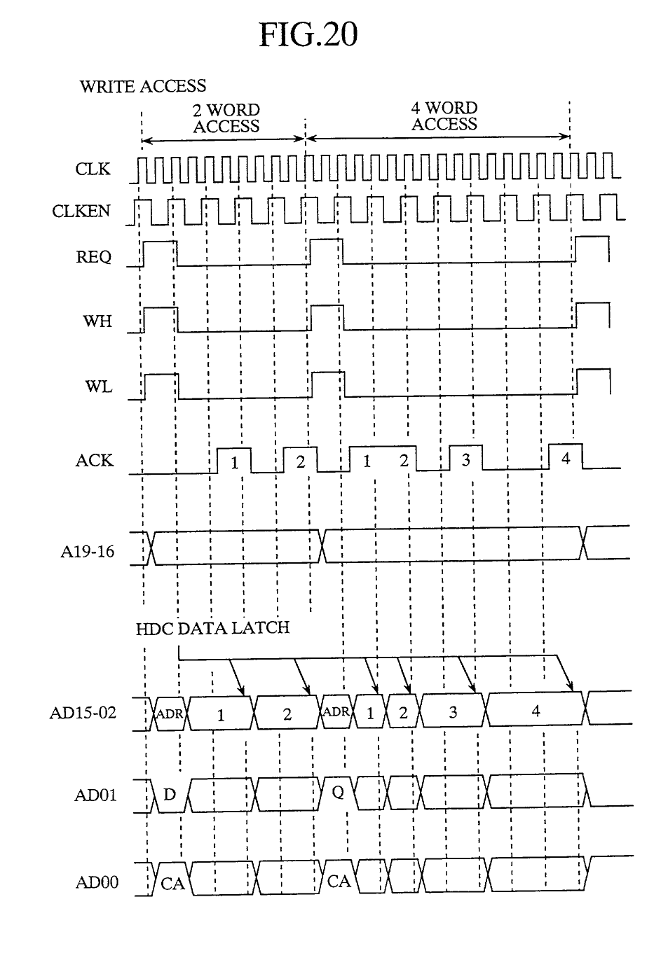

FIG. 20 is a timing chart showing an example of an interface signal between the MCU and the HDC in case of continuous write access;

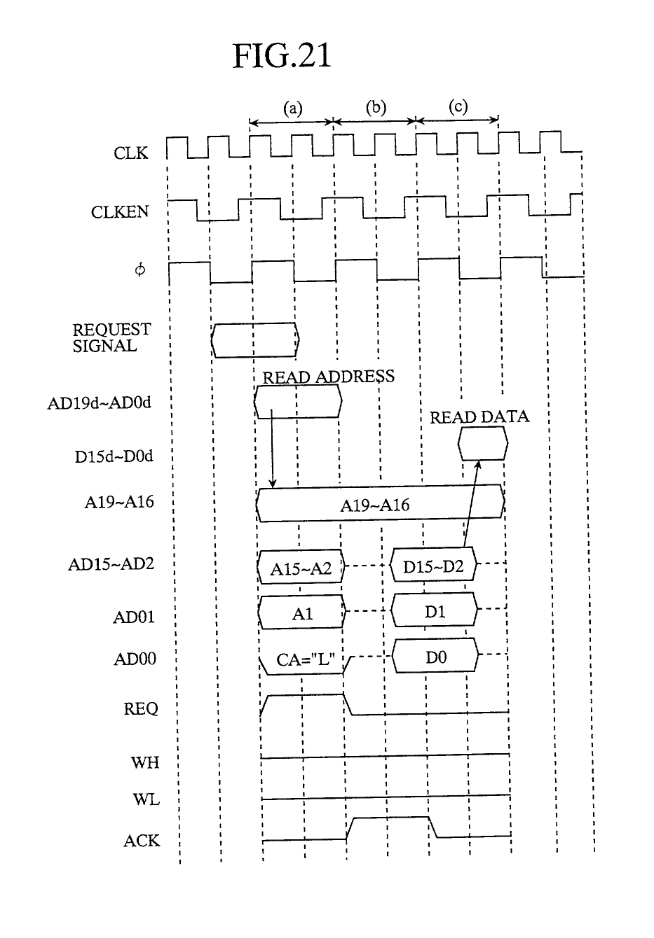

FIG. 21 is a timing chart of a data access/word length/word boundary/ordinary access/read operation;

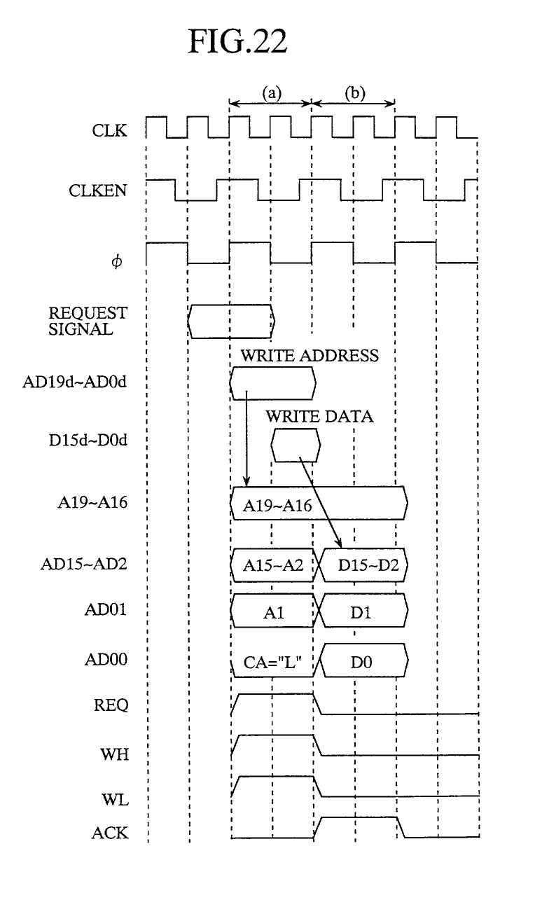

FIG. 22 is a timing chart of an access for writing word-long data from the word boundary;

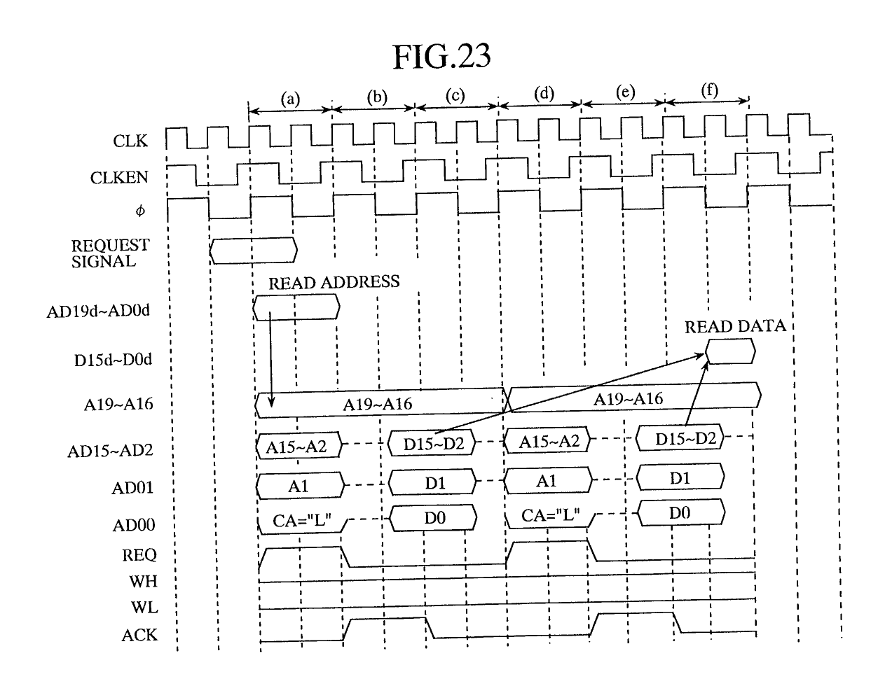

FIG. 23 is a timing chart of an access for reading word-long data from the word boundary;

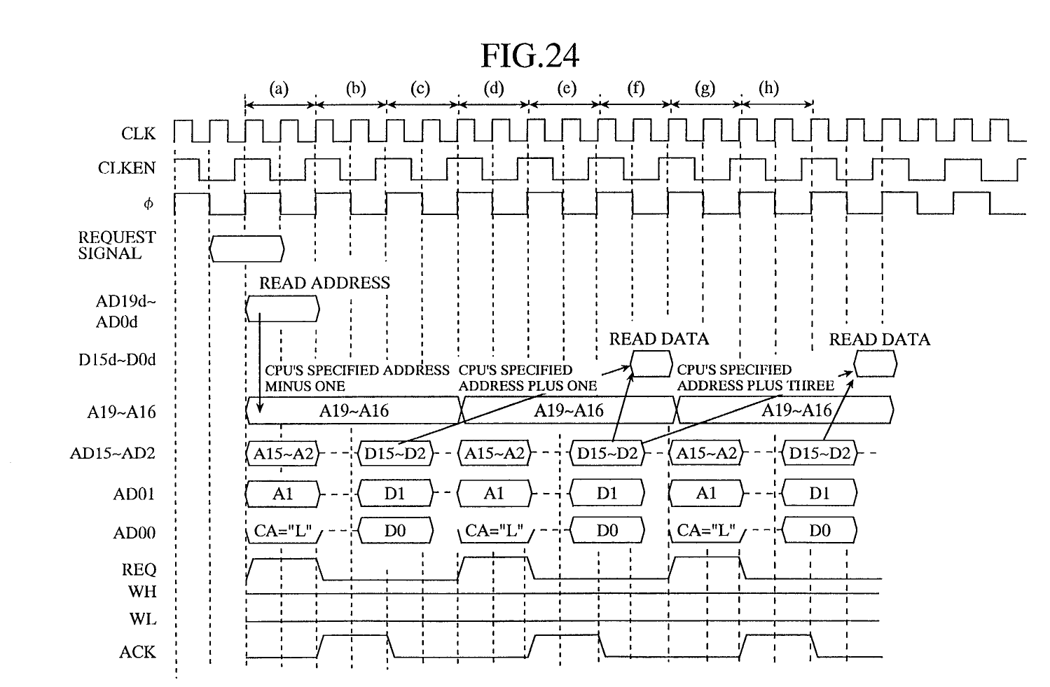

FIG. 24 is a timing chart of an operation for reading double-word data from the word boundary;

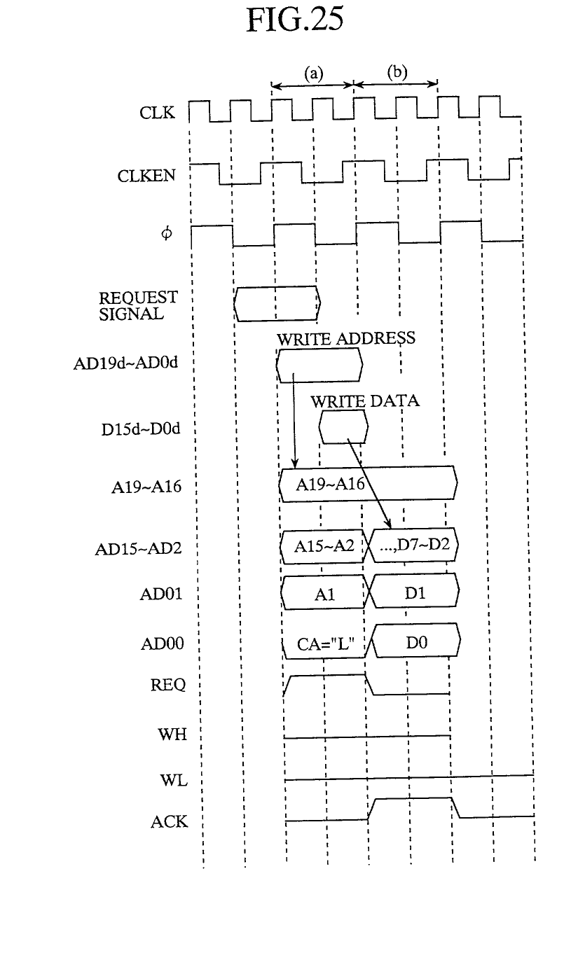

FIG. 25 is a timing chart of an access for writing byte-long data from the word boundary;

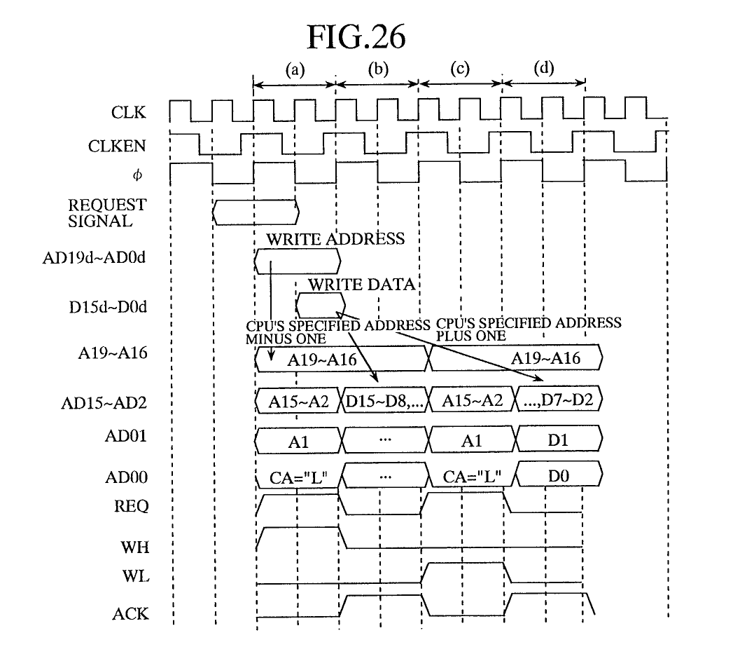

FIG. 26 is a timing chart of an access for writing double-word data from the byte boundary;

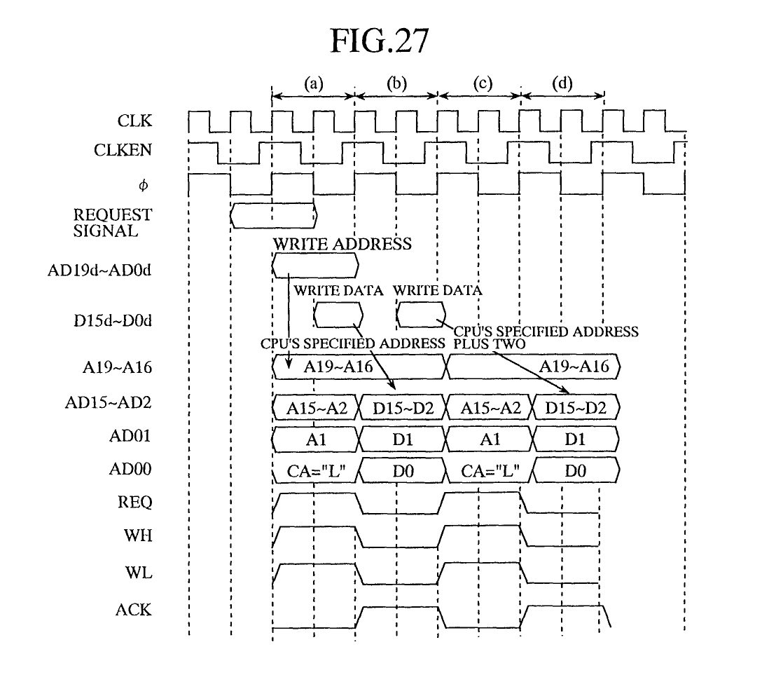

FIG. 27 is a timing chart of an access for writing double-word data from the word boundary;

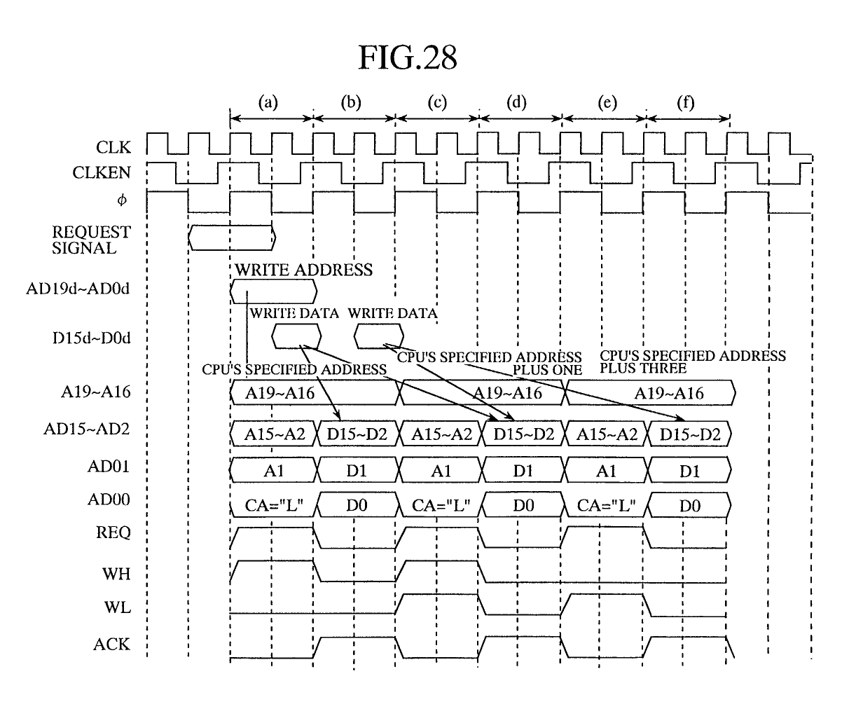

FIG. 28 is a timing chart of an access for writing double-word data from the byte boundary;

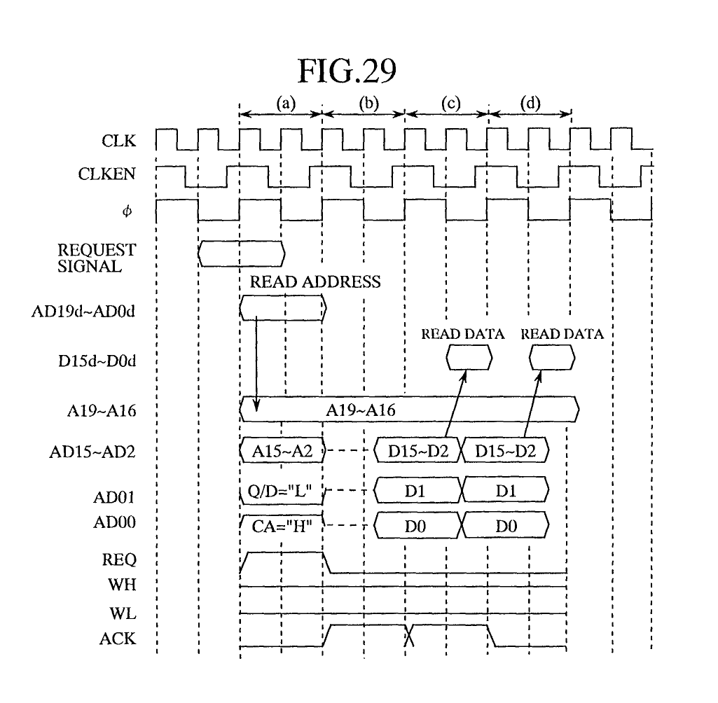

FIG. 29 is a timing chart of an access for reading double-word data from the double-word boundary;

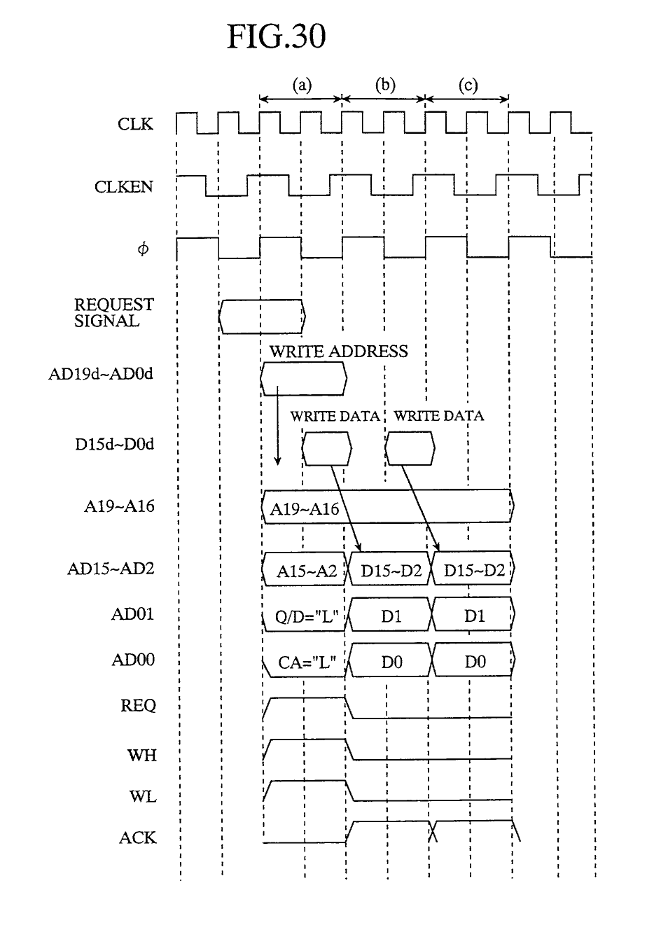

FIG. 30 is a timing chart of a continuous access for writing double-word data from the double-word boundary;

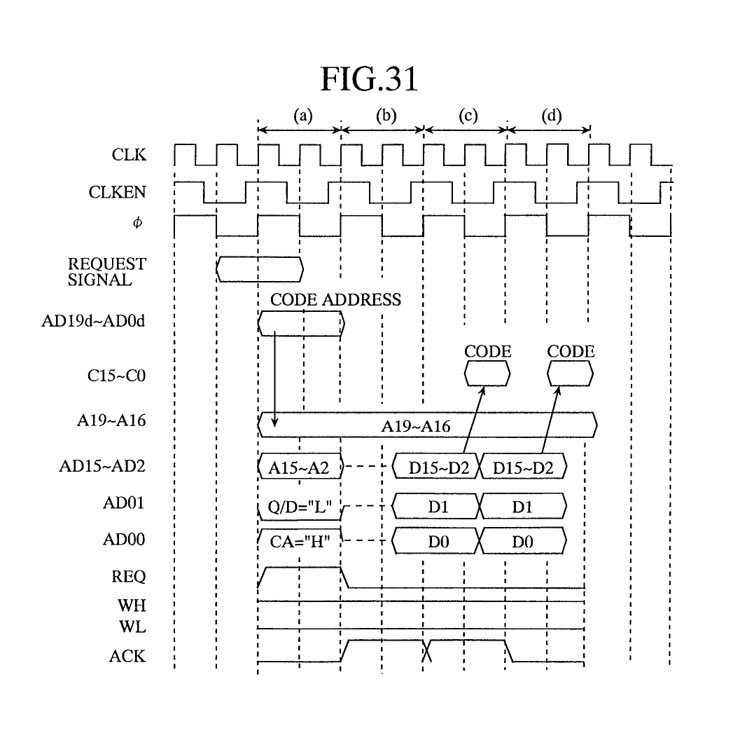

FIG. 31 is a timing chart showing a code access operation at the time of program branching;

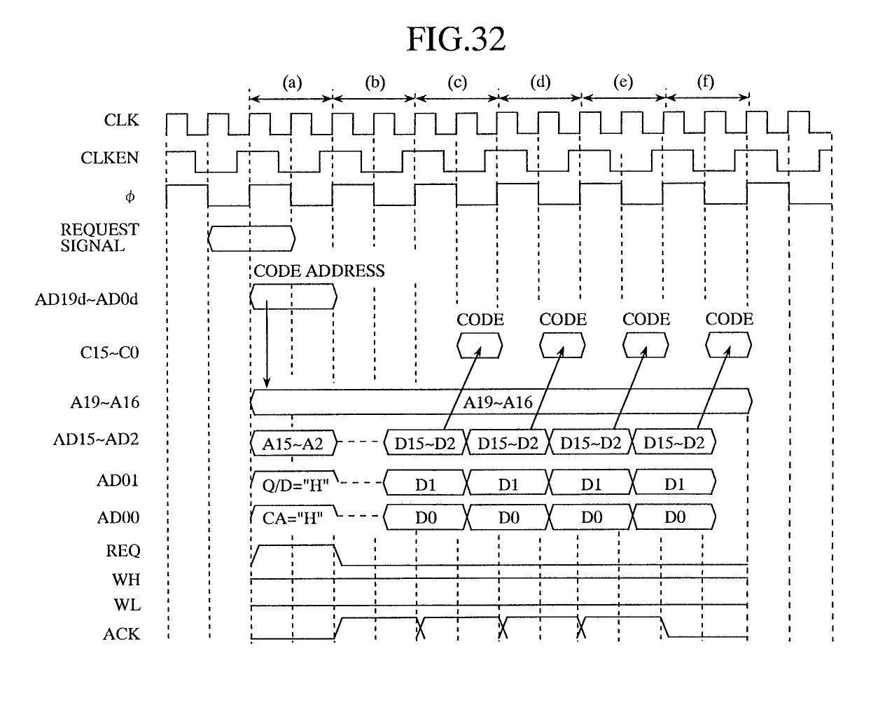

FIG. 32 is a timing chart of a sequential code access for read;

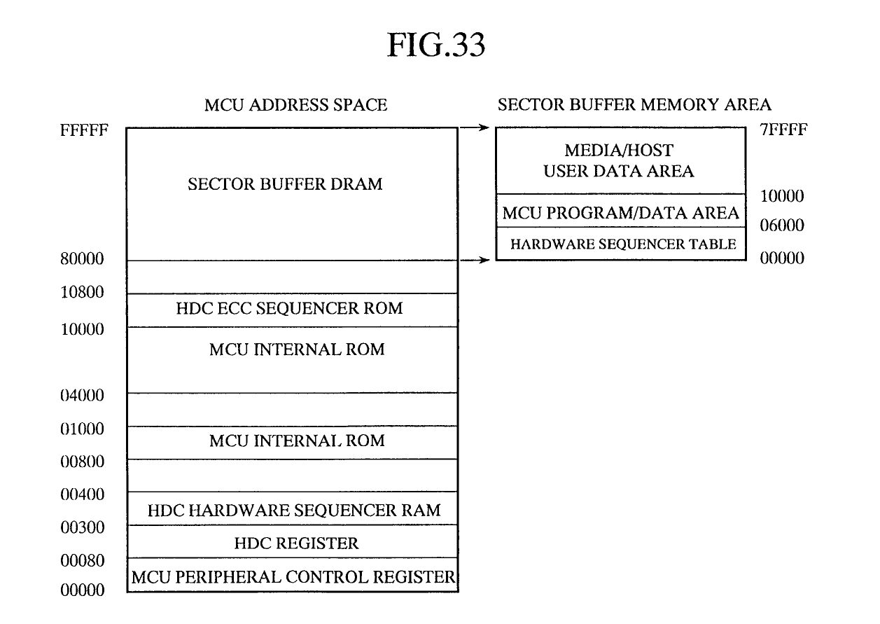

FIG. 33 is a memory map showing the correspondence between the MCU address space and HDC's managing resources;

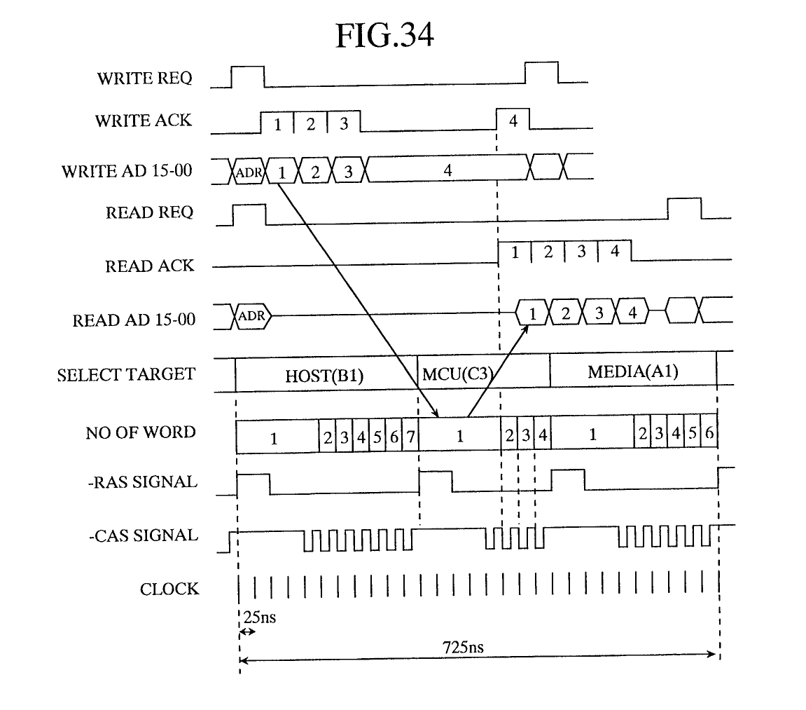

FIG. 34 is an operation timing chart showing a disk media user data transfer, a host user data transfer and data correcting sequencer processing when the MCU makes a four-word access;

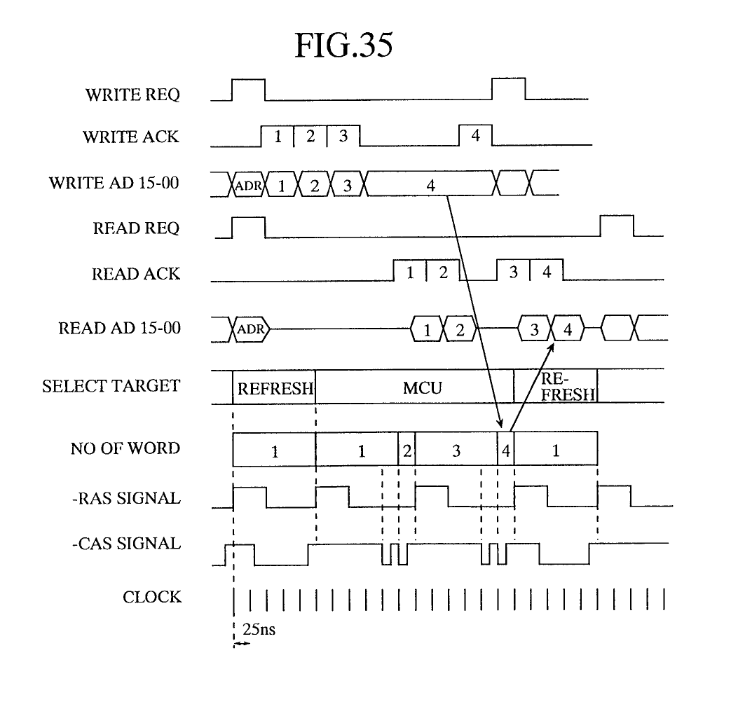

FIG. 35 is an operation timing chart showing the mode of access when four-word access for an MCU program data transfer spans across the page boundary during processing for DRAM refresh and the MCU program data transfer;

FIG. 36 is a block diagram showing a conventional data access unit;

FIG. 37 is a timing chart for explaining data read processing of a microcomputer;

FIG. 38 is a block diagram showing in detail the microcomputer and a ROM;

FIG. 39 is a timing chart showing an ordinary data read method;

FIG. 40 is a timing chart showing a data read method using burst access;

FIG. 41 is a block diagram showing in detail the microcomputer and a DRAM;

FIG. 42 is a timing chart showing an ordinary data read method;

FIG. 43 is a timing chart showing a data read method using a fast page mode;

FIG. 44 is a block diagram illustrating the configuration of an HDD;

FIG. 45 is a timing chart showing an example of an external interface signal of a general purpose MCU in the HDD; and

FIG. 46 is a timing chart showing an example of an EDO-DRAM access in an HDC.

### DETAILED DESCRIPTION OF THE PREFERRED EMBODIMENTS

A detailed description will hereinafter be given, with reference to the accompanying drawings, of the preferred embodiments of the present invention.

EMBODIMENT 1

FIG. 1 illustrates in block form a data access unit according to a first embodiment (Embodiment 1) of the present invention. In FIG. 1, reference numeral 2 denotes a DRAM. Numeral 3 denotes a ROM. Numeral 4 denotes a peripheral device. Numerals 7, 8 and 9 denote a bus, respectively. Numeral 11 denotes a microcomputer that outputs a data access mode designating signal CA and data read addresses A15 to A0. Numeral 12 denotes a dedicated IC that responds to the signal CA and the data read addresses A15 to A0 from the microcomputer 11 to read data D7 to D0 from the specified addresses A15 to A0, and that sends them to the microcomputer 11 in the access mode designated by the signal CA. Numeral 13 denotes a bus that interconnects the microcomputer 11 and the dedicated IC 12.

FIG. 2 is a functional block diagram of the data access unit according to Embodiment 1. In FIG. 2, reference numeral 14 denotes receive means connected via the bus 13 to the microcomputer 11, for receiving therefrom the data access mode designating signal CA and the data read address A15 to A0. Numeral 15 denotes recognize means for recognizing the data access mode from the signal CA received by the receive means 14. Numeral 16 denotes data read means for reading the data D7 to D0 from the read addresses A15 to A0 received by the receiving means 14. Numeral 17 denotes send means connected via the bus 13 to the microcomputer 11, for sending thereto an acknowledge signal ACK upon completion of reading the data D7 to D0 by the data read means 16 and for sending the read-out data D7 to D0 to the microcomputer 11 in the access mode recognized by the recognize means 15.

FIGS. 3 and 4 constitute a flowchart showing the data access method that is applied to the data access units according to the Embodiment 1 and a second embodiment (Embodiment 2) of the present invention.

Now, the operation of the Embodiment 1 will be described.

When the microcomputer 11 needs to read the data D7 to D0 from the ROM 3 via the bus 13 in a normal access mode, that is, when there is no particular need of rapid data read, the microcomputer 11 sends to the dedicated IC 12 an access request signal REQ during one cycle period (cycle “A” in FIG. 5) of the clock signal φ (step ST1). The access request signal REQ is a high-level signal for requesting the dedicated IC 12 to make the necessary access.

Simultaneously, the microcomputer 11 further sends to the dedicated IC 12 the access mode designating signal CA, a data quantity signal QD, a transfer direction signal W, and the data read addresses A15 to A0 (step ST1). The signal CA is for designating an access mode by taking the low level for a normal access mode or the high level for a continuous access mode. The signal QD is for designating the number of bytes to be accessed continuously when the continuous access mode is used by taking the L level for a continuous 4-byte access or the high level for a continues 8-byte access. The signal W is for indicating the direction of data transfer on the bus 13 by taking the low level for the direction from the dedicated IC 12 to the microcomputer 11 or the high level for the direction opposite thereto. The addresses A15 to A0 are the addresses where the data D7 to D0 are stored.

The receive means 14 of the dedicated IC 12 receives these signals from the microcomputer 11, and the recognize means 15 executes required processing based on the received signals. In case of FIG. 5, since both of the mode designating signal CA and the transfer direction indicating signal W are at the low level, the recognize means 15 decides that the requested data be read in the normal access mode (steps ST2, ST3 and ST5).

Accordingly, when the read addresses A15 to A0 indicate addresses in the ROM 3 as is the case with the afore-mentioned prior art example, the data read means 16 of the dedicated IC 12 reads the data D7 to D0 from the addresses A15 to A0 by the ordinary data read method shown in FIG. 39. When the read addresses A15 to A0 indicate addresses in the DRAM 2, the data read means 16 reads the data D7 to D0 by using the ordinary data read method shown in FIG. 42 (step ST6).

Upon completion of the data read by the data read means 16, the send means 17 sends an acknowledge signal ACK (a high-level signal) to the microcomputer 11 to notify it of the end of the data read (step ST7). At the same time, the send means 17 provides the data D7 to D0 read out of the ROM 3 or DRAM 2 onto the data bus in the normal access mode (step ST8). In the FIG. 5 example, since the read-in operation is completed in the cycle “B,” the signal ACK is sent in the cycle “C.”

Thus the microcomputer 11 recognizes the sending thereto of data from the dedicated IC 12 and reads therein the data D7 to D0 from the data bus, with which it terminates the data access operation.

The microcomputer 11 is supplied with the signal ACK from the dedicated IC 12 upon completion of reading the data D7 to D0 by its send means 17 as mentioned above. Accordingly, even if the data read time differs in data accessing objects (the DRAM 2 and the ROM 3 differ in the method of data read therefrom and consequently differ in their data read time), the microcomputer 11 is capable of reading therein the data at appropriate timing regardless of the data accessing object. Hence the general versatility of the microcomputer 11 can be held unimpaired.

When it is necessary for the microcomputer 11 to read therein the data D7 to D0 stored in the ROM 3 or DRAM 2 in the continuous access mode, that is, when it is necessary to rapidly read the data, the microcomputer 11 sends the access request signal REQ to the dedicated IC 12 during one cycle period of the clock signal φ (cycle “A” in FIG. 6).

At the same time, the microcomputer 11 also sends the access mode designating signal CA, the data quantity signal QD, the data transfer direction signal W and the read addresses A15 to A0 to the dedicated IC 12 (step ST1).

Then the receive means 14 of the dedicated IC 12 receives the output signals from the microcomputer 11, and the recognize means 15 and other means of the dedicated IC 12 execute the required processes based on the received signals. In case of FIG. 6, since the designating signal CA is high-level and the transfer direction indicating signal W low-level, the recognize means 15 decides that the data be read in the continuous access mode (steps ST2, ST3, ST9).

Accordingly, as is the case with the afore-mentioned prior art example, when the read addresses A15 to A0 indicate addresses in the ROM 3, the data read means 16 of the dedicated IC 12 reads out therefrom the data D7 to D0 stored at the specified addresses by the data read method using the burst access mode depicted in FIG. 18. When the read addresses A15 to A0 indicate addresses in the DRAM 2, the data read means 16 reads out therefrom the data stored at the specified addresses by the data read method using the fast page mode depicted in FIG. 21 (step ST10).

Upon completion of the data readout by the read means 16, the send means 17 of the dedicated IC 12 sends an acknowledge signal ACK (at the high level) to the microcomputer 11 to notify it of the end of the data readout (step ST11). And the send means 17 outputs the read-out data D7 to D0 onto the data bus of the bus 13 (step ST12).

When the data read means 16 has continuously read 4-byte data as shown in FIG. 18, the send means 17 divides the 4-byte data into four 1-byte data and outputs them successively onto the data bus of the bus 13 (see FIG. 6).

In the FIG. 6 example, since the read is completed in the cycle “B,” the signal ACK is sent over cycles “C” to “F.”

The microcomputer 11 recognizes from the signal ACK the sending of data from the dedicated IC 12 and reads the data D7 to D0 four times in succession from the data bus of the bus 13.

In the continuous access mode the microcomputer 11 needs only to output the access request signal REQ and other signal once to read the 4-byte data. Accordingly, the data read time is shorter than in the normal access mode. In the normal access mode a 12-clock (=3 clock×4) time is needed to read 4-byte data, whereas in the continuous access mode a 6-clock time is enough.

As is evident from the above, according to Embodiment 1, upon completion of data read by the data read means 16, the signal ACK is sent to the microcomputer 11 and at the same time the read-out data is sent thereto in the access mode recognized by the recognize means 15. Hence, this embodiment permits rapid data access of the microcomputer 11 without involving cost-raising means such as extension of the bus width and without impairing the general versatility of the microcomputer 11.

EMBODIMENT 2

FIG. 7 is a functional block diagram of the data access unit according to Embodiment 2 of the present invention. In FIG. 7 the parts corresponding to those in FIG. 2 are identified by the same reference numerals and no description will be repeated.

Reference numeral 18 denotes receive means connected via the bus 13 to the microcomputer 11, for receiving therefrom the data access mode designating signal CA, the data write addresses A15 to A0 and other signals. Numeral 19 denotes recognize means for recognizing the data access mode from the signal CA received by the receive means 15. Numeral 20 denotes data write means connected via the bus 13 to the microcomputer 11 for receiving therefrom data in the access mode recognized by the recognize means 19 and for writing the data in the write addresses A15 to A0 received by the receive means 18. Numeral 21 denotes send means connected via the bus 13 to the microcomputer 11, for sending thereto an acknowledge signal ACK upon completion of the data write by the data write means 20.

Next, the operation of this embodiment will be described.

While above in Embodiment 1 the microcomputer 11 has been described to read the data D7 to D0 from the ROM 3 or DRAM 2 via the dedicated IC 12, provision may be made for the microcomputer 11 to write the data D7 to D0 in the DRAM 2 or ROM 3 via the dedicated IC 12.

When the microcomputer 11 outputs the data D7 to D0 onto the bus 13 in the normal access mode to write the data in the DRAM 2 or ROM 3, that is, when the data need not be written at high speed, the microcomputer 11 sends the access request signal REQ to the dedicated IC 12 during one cycle period (cycle “A” in case of FIG. 8) of the clock signal φ (step ST1).

At the same time, the microcomputer 11 sends to the dedicated IC 12 the access mode designating signal CA, the data quantity signal QD, the data transfer direction signal W and the write addresses A15 to A0 (step ST1).

The receive means 18 of the dedicated IC 12 receives these output signals from the microcomputer 11. Then the recognize means 19 and other means execute the required processing based on the received signals. In case of FIG. 8, since the levels of the signals CA and W are low and high, respectively, the recognize means 19 decides that the data be written in the normal access mode (steps ST2, ST4, ST13).

Hence, in this case, the data write means of the dedicated IC 12 reads in the normal access mode the data D7 to D0 provided on the data bus of the bus 13 from the microcomputer 11 (step ST14). And the data write means 20 writes the data D7 to D0 in the addresses A15 to A0 by the normal data write method depicted in FIG. 9 (step ST15).

When the data write means 20 completes the write of the data D7 to D0, the send means 21 of the dedicated IC 12 sends the signal ACK (high-level) to the microcomputer 11 to notify it of the end of the data write (step ST16). In the FIG. 8 example, the write is completed in the cycle “B” and the signal ACK is sent in the cycle “C.”

The microcomputer 11 recognizes from the acknowledge signal ACK the completion of the data write and finishes the outputting of the data D7 to D0 onto the data bus of the bus 13. The microcomputer 11 is supplied with the signal ACK from the dedicated IC 12 upon completion of writing the data D7 to D0 by its write means as mentioned above. Accordingly, even if the data write time changes with a change in the data-accessing object, the microcomputer 11 is capable of writing the data at appropriate timing regardless of the data-accessing object. Hence the general versatility of the microcomputer 11 can be held unimpaired.

When it is necessary for the microcomputer 11 to write the data D7 to D0 in the ROM 3 or DRAM 2 in the continuous access mode, that is, when it is necessary to rapidly write the data, the microcomputer 11 sends the access request signal REQ to the dedicated IC 12 during one cycle period of the clock signal φ (cycle “A” in FIG. 11) (step ST1).

At the same time, the microcomputer 11 also sends the access mode designating signal CA, the data quantity signal QD, the data transfer direction signal W and the write addresses A15 to A0 to the dedicated IC 12 (step ST1).

Then the receive means 18 of the dedicated IC 12 receives the output signals from the microcomputer 11. And the recognize means 15 and other means of the dedicated IC 12 execute the required processes based on the received signals. In case of FIG. 11, since both of the designating signal CA and the transfer direction indicating signal W are high-level, the recognize means 19 decides that the data be written in the continuous access mode (steps ST2, ST4, ST17).

Accordingly, when the data D7 to D0 are output onto the data bus of the bus 13 from the microcomputer 11, the data write means 20 of the dedicated IC 12 reads therein the data D7 to D0 from the data bus in the continuous access mode (step ST18). Then the data write means 20 writes the data D7 to D0 in specified addresses A15 to A0 by the data write method using the fast page mode depicted in FIG. 10 (step ST19).

When the microcomputer 11 outputs four pieces of data as shown in FIG. 11, they are successively provided onto the data bus of the bus 13.

Consequently, the data write means 20 of the dedicated IC 12 reads therein the data D7 to D0 from the data bus of the bus 13 four times in succession and ends its data access to the microcomputer 11. In the continuous access mode the microcomputer 11 is capable of transferring the four pieces of data to the dedicated IC 12 by sending thereto the access request signal REQ and other signals only once. Accordingly, the data can be transferred in a shorter time than in case of the normal access mode. The time for transfer of four pieces of data in the normal access mode is 12 clocks (=3 clocks by 4) but only 9 clocks in the continuous access mode depicted in FIG. 11, for instance.

Upon completion of the data write by the write means 20, the send means 21 of the dedicated IC 12 sends the signal ACK (high-level) to the microcomputer 11 to notify it of the end of the data write (step ST20). In the FIG. 11 example, the data write is completed in the cycle “H” and the signal ACK is sent in the cycle “I”.

The microcomputer 11 recognizes from the signal ACK the end of the process for writing the data D7 to D0 and finishes outputting the data D7 to D0 onto the data bus of the bus 13.

As is evident from the above, according to Embodiment 2, the receive means 18 receives the data D7 to D0 from the microcomputer 11 in the access mode recognized by the recognize means 19 and writes the data in the write addresses A15 to A0. Hence, this embodiment permits rapid data transfer of the microcomputer 11 without involving expensive means such as an extended bus width and without impairing the general versatility of the microcomputer 11.

EMBODIMENT 3

While Embodiments 1 and 2 employ the bus 13 formed by a plurality of independent signal lines, some of them may be time-shared as depicted in FIG. 12.

The addresses A7 to A2 and the data D7 to D2 use the same signal line; the address A1, the data quantity signal QD and the data D1 use the same signal line; and the access mode designating signal CA and the data D0 use the same signal line.

The signal line for A7/D7 to A2/D2 is used for addresses A7 to A2 or for data D7 to D2, depending upon whether the access request signal REQ is at the high or low level.

Similarly, the signal line for A1/QD/D1 is used for address A1 or for data quantity signal QD, depending upon whether the signal CA is at the low or high level while the access request signal REQ is at the high level. When the signal REQ is at the low level, this signal line is used for data D1.

The signal line for CA/D0 is used for the signal CA or for data D0, depending upon whether the access request signal REQ is at the high or low level.

In case of FIG. 12, however, since no signal line is provided for the address A0, only data access starting at an even boundary is allowed.

When the signal CA is at the high level (corresponding to the continuous access), the address A1 is not output, either. This leads to a restriction that the start address in the continuous access mode be limited specifically to A1=A0=0.

But, according to this embodiment, the number of signal lines forming the bus 13 can be reduced down to 20, whereas it is 29 in the Embodiment 1 shown in FIG. 1.

Incidentally, FIG. 13 is a timing chart showing the timing of each signal when reading data in the continuous access mode.

Although the above embodiments are shown to have the bus 13 shown in FIG. 1 or 12, the invention is not limited specifically thereto nor is it limited to the kinds of signals mentioned above.

EMBODIMENT 4

A fourth embodiment (Embodiment 4) of the present invention will concretely be described in connection with the case where the data access unit and the data access method described above with reference to the first and second embodiments (Embodiments 1 and 2) are applied to the HDD.

The HDD has an HDC and an MCU connected thereto. The HDD controls the HDC and MCU to operate in synchronization with a clock. And plural data input/output operations between the HDC and the MCU, based on a single-access request command from the latter, are each performed continuously, discretely, or in a combination thereof for an arbitrary access time according to the response status created in accordance with the access condition of the HDC's managing resources.

To perform this, when the HDC and the MCU are independent ICs, the clock is supplied from the former to the latter feedback-wise so that they operate synchronously at a high clock frequency. The access begins with a command state in which to output a request signal from the MCU in synchronization with the clock. In this state the MCU outputs access command information such as an address signal of the accessing object, a write identification signal indicating whether the MCU is to read or write, and an access number signal indicating the amount of data transferred that the MCU intends to execute at one time.

When the MCU makes access for write (hereinafter referred to as MCU write access), it goes into a first data output mode in the command or the next state and sends write data onto a data signal line. In a state in which the HDC receives the data, it outputs a response status signal synchronized with the clock and the write data output mode lasts to the end of this state. When the access number is two or more, the MCU enters a second output mode in a state following the first response status signal. Thereafter it repeats processing by the number of times indicated by the access number signal.

When the MCU makes access for read (hereinafter referred to as MCU read access), it goes into a first data input mode in the command or the next state. In a data sending state of the HDC a response state signal, synchronized with the clock, is output from the HDC. The MCU responds to the response status signal to fetch therein data from the data signal line. When the access number is two or more, the MCU enters a second data input mode in the state following the first response status signal. Thereafter it similarly repeats processing by the number of times indicated by the access number signal.

The HDC has registers in which the address signal, the write identification signal and the access number signal output from the MCU in the command state are held by a request signal. Based on the information held in the register, the HDC immediately issues a request for access to its managing resources. The register for holding the address signal is added with an adder and has the function of an up counter.

The HDC further has a ring first-in first-out data register (hereinafter referred to as a FIFO) composed of a plurality of words that is used to match data transfer rates of processing for access from the MCU and processing for access to the HDC's managing resources.

In the MCU write access, while the FIFO data register has an empty area, the HDC outputs the response status signal to the MCU for each access therefrom and loads in the FIFO the data sent from the MCU onto the data signal line. While effective data remains on the FIFO data register, the data is written therefrom into the HDC's managing resources indicated by the address register in accordance with the data receiving condition of the resources. Upon each completion of data write, the address register counts upward by one. The response status signal is generated for each access, but the final response status signal is sent at completion of data write to the resources.

When the MCU makes access for read, data is read out from the resource indicated by the address register into the FIFO data register by the number of times the access is made. Upon each completion of data read, the address register counts upward by one. While effective data is present on the FIFO data register, the response status signal is applied to the MCU upon each data transfer and the data is sent onto the data signal line from the FIFO data register and passed to the MCU.

FIG. 14 illustrates in block form the configuration of an HDD 31 according to Embodiment 4 which employs the data access unit and method of the present invention. In FIG. 14, reference numeral 32 denotes a disk media such as a hard disk. Numeral 33 denotes an MCU. Numeral 34 denotes an HDC. Numeral 36 denotes a sector buffer formed by a DRAM. Numeral 35 denotes a host computer.

In the MCU 33 there are placed, around a CPU 33a and a BIU (control means) 33b for controlling data transfer thereto, a ROM 33c, a RAM 33d, a timer 33e, serial IOs (hereinafter referred to as SIOs) 33f and 33i, a parallel port 33g, an ADC 33h, an interrupt control circuit 33j and an external interface control circuit 33k. Reference numeral 41 denotes a control circuit for controlling a head driving motor and a media driving motor. Numeral 42 denotes a head amplifier connected to a channel. Numeral 43 denotes the channel, which is formed by an IC for conversion of a signal fit for magnetic recording to a digital signal for use in the HDC 34 and from the latter to the former. The channel is connected to the ADC 33h of the MCU 33 and a servo control circuit of the HDC 34.

In the HDC 34 there are placed a clock generator 34a, a clock distributor (clock synchronizing means) 34b, an MCU interface command control circuit (control means) 34c, FIFO data registers 34d, 34k and 34m, an address register 34e, a sector buffer control circuit 34f, a servo control circuit 34g, a register circuit 34h, a disk media control circuit 34i and a host control circuit 34j. Reference numeral 34s denotes an MCU interface control circuit.

FIG. 15 illustrates in block form the configuration of the MCU interface control circuit 34s depicted in FIG. 14. In FIG. 15, reference numeral 34t denotes a latch circuit ADL. Numeral 34u denotes a latch circuit QL. Numeral 34v denotes a latch circuit CAL. Numeral 34w denotes a latch circuit WHL. Numeral 34x denotes a latch circuit WLL.

FIG. 16 illustrates in block form the configurations of the CPU 33a, BIU 33b and the external interface control circuit 33k of the MCU depicted in FIG. 14. In FIG. 16, reference numeral 51 denotes an address generator. Numeral 52 denotes a data queue. Numeral 53 denotes an instruction queue. Numeral 54 denotes a bus cycle start control circuit. Numeral 55 denotes a fetch and data read/write control circuit. Numeral 56 denotes an external access control signal generator. Numeral 57 denotes a clock generator (clock synchronizing means) for generating a clock φ of the MCU 33 from clocks CLK and CLKEN supplied from the HDC 34.

Next, the operation of this embodiment will be described.

A description will be given first of the operation of the HDC side.

The control circuit 41 in FIG. 14 is connected via the SIO 33f to the MCU 33 to control the head driving motor and a media driving motor. The head amplifier 42 is connected to the channel 43 and is controlled through the parallel port 33g of the MCU 33. The channel 43 converts a signal fit for magnetic recording to a digital signal that is used in the HDC 34 and vice versa. The channel 34 is connected to the disk media control circuit 34i of the HDC 34 and transfers data thereto. Servo information for head position control is also created in the channel 43. The channel 43 is controlled through the SIO 33i of the MCU 33.

The DRAM used as the sector buffer 36 is placed under the control of the sector buffer control circuit 34f. With a 40-MHz clock, the period of the page mode becomes 25 ns, imposing severe limitations on the timing for reading the DRAM. In Embodiment 4, signal outputs RAS, CASU and CASL sent to the DRAM are fed back to the HDC 34 via input circuits 34p and 34q and changing points of these signals are utilized to correct delay time variations of the input/output circuit to ensure accurate data latching. In the MCU 33 a 20-bit address output signal line, a 32-bit program input signal line and a 26-bit data output/input signal line are independently set between the BIU 33b and ROM 33c, RAM 33d. Due to limitations on the number of signal pins used, however, a signal line is shared by addresses and data that are sent to the outside. And also, data input/output also share one signal line. Because of the sharing, the external interface control circuit 33k is provided.

CLK is a clock that is sent from the HDC 34 to the MCU 33. The clock generator 34a in the HDC 34 generates it. CLKEN is a marker signal obtained by frequency dividing the clock CLK so that its changing point is between low levels of the latter. The marker signal CLKEN is also created in the HDC 34 and sent to the MCU 33. CLK and CLKEN output circuits in the HDC 34 are each added with an input circuit from the outside. The clock that is sent to the MCU 33 is simultaneously fed back to the HDC 34 and distributed, as a reference clock, by the clock distributor 34b to the circuits in the HDC 34. The clock input circuit and the clock distributor in the HDC 34 and the MCU 33 are set so that no substantial difference arises between their delay times. By this, the clocks in the respective chips of the HDC 34 and MCU 33 can be timed to each other with their CLK connection line considered as a reference point. Hence interface signals can be synchronized with the clock.

The basic cycle that the MCU 33 uses is a 2-clock cycle period (50 ns). CLKEN is used to enable both of the HDC 34 and the MCU 33 to identify the clocks CLK corresponding to their basic cycles, respectively. The leading edge on the clock CLK where the signal CLKEN is at the high or low level is the point of synchronization. All interface signals vary a little after this point.

FIG. 17 is a timing chart showing an example of one-word access by the interface signal between the MCU 33 and the HDC 34. REQ is a request signal, which indicates the start of sending commands and the access start of the MCU 33. In the same cycle command information, such as high-order and low-order byte write identification signals WH, WL, access addresses A19 to 16 and AD15 to 02, a continuous access signal AD00, and a continuous access number AD01, are output. The continuous access signal AD00 is output for accessing data of two or more words in response to one request signal. In this instance, such processing as depicted in FIG. 18 is carried out. The contents of processing by the high-order and low-order byte write identification signals WH and WL are such as shown in FIG. 19.

In case of data read, there is no distinction between high- and low-order bytes. The data is exchanged and discarded by internal processing of the MCU 33. In case of continuous access, the data is always processed word by word in both of write and read. The address can directly be designated up to 1 Mbytes.

When the MCU 33 writes, it sends write data onto the bus AD15 to 00 in the cycle next to the cycle where the request signal REQ has risen. In the same cycle the response status signal ACK is output from the HDC 34 and the access is completed. In case of read by the MCU 33, too, the signal ACK is output from the HDC 34 in the cycle next to the REQ′ risen cycle. But, to avoid a signal collision accompanying the switching of the direction of data transfer, the HDC 34 outputs data in a half cycle. The MCU 33 loads thereinto the data after one cycle and completes the access after a half cycle. Thus the state and cycle of processing do not always coincide with each other but they are all executed in synchronization with the clock.

The timing for outputting the signal ACK is dependent on the processing state of the HDC 34. The access time can be extended over a plurality of cycles. Since the MCU 33 and the HDC 34 are synchronized with the clock, resources that are accessible in a short time, such as the registers on the HDC 34, can be accessed in a short time without the necessity for deferring the outputting of the signal ACK.

In case of the continuous access, the leading address is output from the MCU 33 in the REQ cycle, and the up counting of the adder in the HDC 34 creates the subsequent addresses. In Embodiment 4 the data that is handled is two- or four-word and the timing of outputting the signal ACK can be set continuous, discrete or a combination thereof for each word, depending on the processing condition of the HDC 34.

Now, the operation of the MCU side will be described.

The MCU 33 determines the number of words to be continuously accessed in accordance with the contents of processing. For example, one word is chosen for the execution of a 16-bit read instruction, two words for the execution of a 32-bit write instruction and four words for an instruction fetch. In this way, the most efficient number of words is chosen for each request. The BIU 33b and the external interface control circuit 33k perform processing accordingly. In FIG. 20 there are shown examples of interface signals between the MCU 33 and the HDC 34 in case of continuous access for write.

In FIG. 16 the MCU 33 generates the clock φ by the clock generator 57 from the signals CLK and CLKEN input from the HDC 34. In the MCU 33 all operations are based on the clock φ. The bus cycle that the BIU 33b executes, which is an operation of reading or writing data from or to other devices or other circuit blocks in the same chip via a bus, is roughly divided into a data access and a code access. They are subdivided into the following categories according to the features such as the position of the leading address (byte boundary=odd address, word boundary=even address, double-word boundary=least significant two bits of address are “0” address), the length of data or code to be read and write (byte=8 bits, word=16 bits, double word=32 bits, quad word=64 bits), the access mode (normal access and continuous access), the read or write mode in case of data access and the program branching mode or sequential access mode in case of code access, and so forth.

(1) Data Access

(1-1) Byte length/Word boundary/Normal access/Read or Write

(1-2) Byte length/Byte boundary/Normal access/Read or Write

(1-3) Word length/Word boundary/Normal access/Read or Write

(1-4) Word length/Byte boundary/Normal access/Read or Write

(1-5) Double-Word length/Double-Word boundary/Continuous access/Read or Write

(1-6) Double-Word length/Word boundary/Normal access/Read or Write

(1-7) Double-Word length/Double-Word boundary/Normal access/Read or Write

(2) Code Access

(2-1) Double-Word length/Double-Word Boundary/Continuous Access/Branch

(2-2) Quadword length/Double-Word boundary/Continuous access/Sequential access

Next, the operation of bus cycle will be described in detail in connection with the case of Data access/Word length/Word boundary/Normal access/Read. FIG. 21 is a timing chart showing the operation.

Data access occurs with a request signal from the CPU 33a to BIU 33b. The request signal is composed of plural signals and contains information that indicates whether or not to request data access, whether the access is for read or write, and the length of data to be handled. It is output for one cycle of the clock φ from its low-level to the high-level period as shown in FIG. 21. The CPU 33a sends read addresses AD19d to AD0d to the address generator 51 of the BIU 33b for one cycle (a) of the next clock φ from its high-level period. The bus cycle start control circuit 54 receives and decodes the request signal from the CPU 33a and sends to the fetch and data read/write control circuit 55 a command for starting a bus cycle (read access for word-long data in this case) in accordance with the contents of the request. The fetch and data read/write control circuit 55 suitably controls the address generator 51, the data queue 52 and the external access control signal generator 56 to actuate external interface terminals of the MCU 33, thereby reading out the data of the designated length from the addresses specified by the CPU 33a. As regards the access method, the fetch and data read/write control circuit 55 selects either the normal access or the continuous access according to the access condition. In this case, the normal access is selected.

The operation of each circuit block for operating the external interface terminals of the MCU 33 at the timing depicted in FIG. 21 will be described below in more detail.

The address generator 51 receives the address signals AD19d to AD0d (the leading address of the data to be read) sent from the CPU 33a and outputs them intact as signals A19 to A0 for the cycle (a) in FIG. 21. Of the signals A19 to A0, the signals A19 to A11 are output via terminals A19 to A16 and terminals AD15 to AD01 and sent as addresses for access to the HDC 34. Since every read access is processed as a word access from the word boundary (an even address), the least significant bit A0 need not be output to the outside. A processing method for byte-data read access or word access from the byte boundary will be described later on. In the same cycle (a) as that in which the read addresses are output, the external access control signal generator 56 forces the signal REQ to the high level, notifying the HDC 34 of the start of access.

In this case, since the access is read access, the signals WH and WL are both at the low level as shown in FIG. 19, from which the HDC 43 learns that the access is read access. Further, in this instance, since the normal access is chosen, signals CA and Q/D that are output from the external access control signal generator 56 are low-level. The signal CA is output through a terminal AD00 to notify the HDC 34 of the normal access. Thus, in this cycle (a) the MCU 33 sends the access condition and the accessing address to the HDC 34.

The next cycle (b) is a wait cycle in which the MCU 33 waits for an acknowledge signal ACK from the HDC 34. In this cycle (b) the terminals A19 to A16 and AD15 to AD00 are in the high-impedance state, and the signals REQ, WH and WL are low-level. In the case where the HDC 34 is capable of returning the read data to the MCU 33 in the next cycle (c), it forces the signal ACK to the high level to notify the MCU 33 of that effect. The signal ACK is sent to the fetch and data read/write control circuit 55 of the MCU 33. When the signal ACK is high-level in the cycle (b), the fetch data read/write control circuit 55 proceeds to the next cycle (c), but when the signal ACK is low-level, the cycle (b) is repeated once more. Accordingly, when reading the designated data takes much time, synchronization of the interface of the HDC 43 with the MCU 33 can be maintained by deferring the timing for sending the signal ACK to the latter.

After sending the signal ACK of the high level to the MCU 33, the HDC 34 outputs read data to the terminals AD15 to AD00 at the trailing edge of the clock φ in the next cycle (c). The MCU 33 fetches thereinto the read data from the terminals AD15 to AD00 by the trailing edge of the clock φ. The read data is once stored in the data queue 52 via signal lines D15 to D0 and immediately sent to the CPU 33a in the low-level period of the clock φ in the cycle (c). Thus the data read process is completed.

Next, a description will be made of access for writing word-long data from the word boundary. FIG. 22 is a timing chart in this case. As is the case with the read operation, a request signal indicating the access condition is set from the CPU 33a to the bus cycle start control circuit 54. In response to the instruction from the start control circuit, the data read/write control circuit 55 executes the bus cycle of the write access. The address generator 51 receives write addresses AD19d to AD0d from the CPU 33a and outputs them as signals A19 to A0 in the cycle (a). Among them, the signals A19 to A1 are output as address signals to the outside via terminals A19 to A16 and AD15 to AD01. Since it is designated by the signals WH and WL whether the data to be written is byte- or word-long, the least significant bit A0 of the address need not be output to the outside. In the low-level period of the clock φ in the cycle (a), the CPU 33a further outputs write data to terminals D15d to D0d. The write data is once stored in the data queue 52. In the cycle (a) the external access control signal generator 56 forces the signal REQ to the high level and also both of the signals WH and WL to the high level, notifying the HDC 34 of the word-long data write access. The signals WH and WL are signals that designate write processing. The signal WL at the low level designates that the low-order byte of the data, that is, data to be output to the terminals AD7 to AD00 in the next cycle (b), be written in the even address side (addresses A19 to A16, AD15 to AD01 and 0) of the address. The signal WH at the high level designates that the high-order byte of the data, that is, data to be output to the terminals AD15 to AD8 in the next cycle (b), be written in the odd address side (addresses A19 to A16, AD15 to AD01 and 1) of the address.

Accordingly, when word-long data is written, the signals WH and WL both go high. In this case, too, the normal access is used, so that the signals CA and Q/D are low-level and the signal CA is output via the terminal AD00. Next, in the cycle (b) the write data stored in the data queue 52 is provided to the terminals AD15 to AD00. When the HDC 34 is capable of receiving the write data and completing the write process in this cycle, it forces the signal ACK to the high level in this cycle, indicating it to the MCU 33. Upon receiving the signal ACK of the high level, the MCU 33 terminates the write access with this cycle. On the other hand, when more cycles are needed for the HDC 34 to complete the write process, it defers the timing for sending the signal ACK to the MCU 33. The fetch and data read/write control circuit 55 of the MCU 33 repeats the cycle (b) and continues outputting the write data to the AD15 to AD00 until the signal ACK of the high level is sent from the HDC 34.

The read access for the byte data from the word boundary is executed as read access for word data at the same timing as in FIG. 21. Of the word data stored in the data queue 52, only the low-order byte data is sent to the CPU 33a. The read access for byte data from the byte boundary is converted to a read access for word data from the word boundary at an address (A19 to A16, AD15 to AD01 and 0) immediately before the access address designated at the address outputting time. This converted read access is made at the same timing as in FIG. 21. Among the word data stored in the data queue 52, only the high-order byte data is sent to the CPU 33a.

The word read from the byte boundary is executed, as depicted in FIG. 23, in two stages of a word read from the word boundary at an address (AD19d to AD1d and 0) immediately before the designated address and a word read form the word boundary at an address (AD19d to AD0d+1) immediately after the designated address. The address generator 51 has an adder and a data address register. In the cycle (a) the write address AD19d to AD0d sent from the CPU 33a is incremented by one and the incremented value is stored in the data address register. The read address for the second word read, which starts with a cycle (d), is output from the data address register. The leading and ending bytes of the read-out two-word data are discarded and only one word in the middle of the data is sent to the CPU 33a. A double-word data read from the word boundary is executed in two stages similarly to the word read from the byte boundary illustrated in FIG. 23. In this instance, however, the read-out two-word data is all sent to the CPU 33a.

The read of the double-word from the byte boundary is executed, as depicted in FIG. 24, in three steps of a word read from the word boundary at an address immediately before the designated address, a word read from the word boundary at an address immediately after the designated address and a word read from the word boundary at an address three addresses after the designated address. The addresses for the second and third accesses are generated by the adder and the data address register in the address generator 51. Of a total of six words read out, the first and last bytes are discarded and the middle two words are sent to the CPU 33a.

The access timing for writing the byte data from the word boundary is depicted in FIG. 25. This write access differs from the a write access for word data in that only the signal WL goes high in the cycle (a) and that only the byte data output to the terminals AD7 to AD00 is written in the cycle (b).

The write access for the byte data from the byte boundary is executed at the same timing as in FIG. 25. In the cycle (a) only the signal WH goes high, instructing the HDC 34 to write only the byte data output to the terminals AD15 to AD8 in the cycle (b).

The write access for the byte data from the byte boundary is executed, as depicted in FIG. 26, in two steps of a write access for byte data from the byte boundary and write access for byte data from a word boundary at an address of the designated byte boundary plus one address.

The write access for the double-word data from the word boundary is executed, as shown in FIG. 27, in two steps of a word data write from the designated word boundary and a word data write from the word boundary two addresses after the designated word boundary. the write access for the double-word data from the byte boundary is executed, as shown in FIG. 29, in three steps of a write access for byte data from the designated byte boundary, a write access for word data from the word boundary one address after the designated byte boundary and a write access for byte data from the word boundary three addresses after the designated byte boundary.

The above has described the operations of all data accesses that are processed by the normal access method. The continuous access is a method that reads or writes data once from the address sent once from the MCU 33. For example, Embodiment 4 uses 16 signal lines AD15 to AD00 for data exchange between the MCU 33 and the HDC 34; hence, the data that can be exchanged by the normal access at one time is byte- or word-long. Therefore, as described previously, the word access from the byte boundary or the double-word access from the byte/word boundary is executed in a plurality of bus cycles by sending the address twice and three times.

In the MCU 33 in Embodiment 4, the continuous access is offered as an access method which permits efficient read/write of long data stored in contiguous addresses as compared with the conventional normal access method. With the continuous access method, when the address boundary placed at the beginning of data satisfies a specific condition (the double-word boundary, for instance), the data read/write cycle is executed the specified number of times although the address is sent only once.

Next, the operation of the continuous access method will be described in connection with the read access for the double-word data from the double-word boundary. FIG. 29 is a timing chart for explaining the operation in this instance. As is the case with the normal access method, a request signal indicting an access condition is sent from the CPU 33a to the bus cycle start control circuit 54. The fetch and data read/write control circuit executes the read access for the double-word data. The address generator 51 receives and sends the address from the CPU 33a as an address signal A19 to A0 to the external interface control circuit 33k in the cycle (a). The least significant two bits A1 and A2 of the address signal is also sent to the fetch and data read/write control circuit 55. From this address information and the bus cycle start-up instruction based on the access condition sent from the CPU 33a, the fetch and data read/write control circuit 55 recognizes that the access is a read access for double-word data from the double-word boundary. Thus it decides that the access method is the continuous access and notifies the external access control signal generator 56 of the use of the continuous access method. The external access control signal generator 56 generates the signal REQ in the cycle (a) as in case of the normal access and, because of the read access, holds the signals WH and WL at the low level. Furthermore, in the cycle (a) it makes the signal CA high-level because of the continuous access and the signal Q/D low-level since the read data length is double-word.

The signal CA indicates the access method: the normal access by the low level and the continuous access by the high level. The signal Q/D indicates the length of data that is continuously exchanged in the continues access mode: the double-word (two-word) length by the low level and the quad-word (four-word) length by the high level. The external interface control circuit 33k sends the signal CA via the terminal AD00C 34 to the HDC 34 to notify it of the continuous access method being used. When the signal CA is at the high level, the signal Q/D, not the address signal AD1, is sent via the terminal AD01 to the HDC 34 to notify it of the length of data to be continuously access. Accordingly, the address signals that are sent to the HDC 34 in the continuous access are AD19 to AD2, but since the continuous access starts only from the double-word boundary (A1=A0=“0”), the address signals need not be sent from the MCU 33 to the HDC 34.

As described above, the HDC 34 receives the signals REQ, WH, WL, CA, Q/D and A19 to AD2 from the MCU 33 in the cycle (a) and recognizes that the access from the latter is the continuous access to read the double word starting at the address (AD19 to AD2, 0, 0). In the next cycle (b), as is the case with the normal access, the MCU 33 puts the terminals AD15 to AD00 in the high-impedance state and makes the signal levels at the terminals REQ, WH and WL low, waiting for an acknowledge signal ACK from the HDC 34.

On the other hand, when the low-order word (addresses A19 to AD2, 0, 0 and addresses 0, 1) of the double-word data requested by the MCU 33 to read can be sent thereto in the next cycle (c), the HDC 34 sends the acknowledge signal ACK to the MCU 34 in the cycle (b) and the read data (the low-order word) in the cycle (c). In the cycle (c) the MCU 33 reads therein the read data (the low-order words) from the HDC 34 by the trailing edge on the clock φ and passes it to the CPU 33a in the low-order period of the clock φ. At the same time, the MCU 33 waits for an acknowledge signal ACK from the HDC 34 concerning the next data (the high-order word). When the high-order word (addresses A19 to AD2, 1, 0 and addresses 1, 1) can be sent to the MCU 33 in the subsequent cycle (d), the HDC 34 sends an acknowledge signal ACK of the high level to the MCU 33 in the cycle (c) and the read data in the cycle (d). In the cycle (d) the MCU 33 reads therein the read data (the high-order word) by the trailing edge on the clock φ and passes it to the CPU 33a in the low-level period of the clock φ. Then the read operation by the continuous access ends. By controlling the acknowledge signal ACK, the HDC 34 is capable of controlling the timing for sending the read-out data for each word.

FIG. 30 is a timing chart explanatory of the operation for writing double-word data from the double-word boundary by the continuous access. No description will be made of this write operation because it can easily be understood from the description given above of the read/write operations by the continuous and normal access methods.

Next, the code access will be described.

The code access is executed in either one of the two continuous access modes listed below.

(1) Access for double-word read from the double-word boundary (program branching)

(2) Access for quad-word read from the double-word boundary (sequential access)

A description will be given first of the code access operation in case of program branching.

FIG. 31 depicts the operation timing in this case. As is the case with the data access, the code access starts with the generation of a branch request signal from the CPU 3a. In the cycle (a) the address generator 51 receives branch addresses AD19 to AD0d from the CPU 33a and passes them intact as signals A19 to A0 to the external interface control circuit 33k. The fetch and data read/write control circuit 55 recognizes through the bus cycle start control circuit 54 that the request from the CPU 33a is an access for reading a code in case of program branching. It instructs each block to execute the operation for reading the double word from the addresses A19 to A2, 0, 0 in the continuous access mode. The external access control signal generator 56 responds to this instruction to make the signal REQ high-level, the signal AD01 (CA) high-level and the signals AD00 (Q/D), WH and WL low-level in the cycle (a), instructing the HDC 34 to read the double word from the addresses A19 to A2, 0, 0. The subsequent code readout procedure is exactly the same as that for the data read by the continuous access method.

The code access differs from the data access in that the codes, which are read for each from the terminals AD15 to AD00, are fetched in the instruction queue 53, not in the data queue 52. In this instance, however, the branch addresses AD19d to AD0d=A19 to A0 are not limited specifically to the double-word boundary (A1, 0=“0”) but indicate an arbitrary address boundary. Hence, the read-out double word may sometimes contain unnecessary codes according to the contents of the signal A1, 0. The unnecessary codes are discarded by an instruction of the fetch and data read/write control circuit 55 monitoring the signal A1, 0 when the read-out codes are stored in the instruction queue 53. The address generator 51 has an address adder and a program address register. Based on the branch address, addresses A19 to A2, 0, 0 plus four addresses are stored in the program address register in the cycle (a) for use in the subsequent sequential code access. The codes stored in the instruction queue 53 are transferred to the CPU 33a upon each request therefrom.

Next, the sequential code access for read will be described.

FIG. 32 depicts its operation timing. In the case where no program branch instruction is provided from the CPU 33a and no data read/write operation is performed and hence the bus is idle, the BIU 33b generates a code access and loads the read-out codes in the instruction queue 53 before the CPU 33a actually requires them. For example, Embodiment 4 has an instruction queue capable of storing codes of 10 bytes. After branching of the program, the address of the next code access is stored in the program address generator of the address generator 51. This address surely indicates the double-word. In the absence of program branch and data read/write requests from the CPU 33a and if the instruction queue 53 has an 8-byte or more free space, the bus cycle start control circuit 54 instructs the fetch and data read/write control circuit 55 to read the quad-word code in the continues access mode. The fetch and data read/write control circuit 55 responds to this instruction to control the respective circuit blocks.

The address generator 51 outputs, in the cycle (a), the contents of its address latch as a signal (AD19 to AD0) and sends it to the external interface control circuit 33k. This address signal is incremented by eight by the address adder and the added output is stored again in the address latch. The external interface control signal generator 56 forces the signal REQ to the high level, the signal CA to the high level, the signal Q/D to the high level and the signals WH and WL to the low level, instructing the HDC 34 to read four words from the addresses AD19 to AD2, 0, 0 in the continuous access mode. The subsequent code readout is performed in the same manner as that for the double-word read out; only the readout repeat count increases and the read-out codes are sequentially stored in the instruction queue 53.

Turning back to FIG. 15, the operation of the MCU interface control circuit 34s will be described.

The MCU interface command control circuit 34c generates register and sector control signals. The address (A19 to 16, AD15 to 01) sent by the signal REQ from the MCU 33 is latched in the latch circuit (ADL) 34t. The write signals (WH, WL) are latched in the latch circuit (WHL) 34w and in the latch circuit (WLL) 34x, respectively. The continuous access signal (AD00) is latched in the latch circuit (CAL) 34v and the continuous access number (AD01) in the latch circuit (QL) 34u. Since access contention control may sometimes be necessary according to resources, the request signal (RQ) and the address (ADRS) are sent, simultaneously with latching of the command, to the resource to be accessed on the assumption of the dada access for read by the MCU 33 regardless of its actual purpose of access. A FIFO (MRB) 34d for temporarily storing data has a three-word configuration and is shared by read and write operations. At the time of requesting access the FIFO 34d is initialized and used in the order 0-1-2. Pointers indicating a buffer to be written and a buffer to be read are set. The read and write operations can be carried out independently and the former can immediately follow the latter.

In case of read by the MCU, read-out data is input via a bus RDAT into the FIFO 34d from the resource and then sent to the MCU (AD15 to 00). In case of write by the MCU, since the outputting of the write data to AD15 to 00 begins in the cycle following the signal REQ, the data is input into the FIFO 34d, from which it is send via a bus WDAT to the resource together with the request signal (RQ), the write signals (HW, LW) and the address (ADRS).

When CAL=1, the continuous access is made, and if the latch circuit (QL) 34u is 0, two or four words are processed depending upon whether the latch circuit (QL) 34u is 0 or 1. In the write operation, when the HDC 34 receives third word data, the MCU 33 outputs the forth word and enters the wait state and a free space is provided in the FIFO 34d. In the read operation, too, when the HDC 34 sends the signal ACK, the MCU 33 quickly reads data and a free space is similarly provided in the FIFO 34d. Accordingly, in case of the continuous access up to four words, a three-word space is enough for the FIFO 34d.

When the resource is immediately accessible like a register, the MCU interface command control circuit 34c generates the signal ACK. In case of a resource that cannot immediately be accessed such as a ROM on the HDC 34 for use by ECC (Error Check and Correction) sequencer, a RAM on the HDC 34 for use by various hardware sequencers or sector buffer, or in case of a resource of the type that the access thereto is delayed by a contention with hardware, the signal ACK is generated based on the acknowledge signal (AK) sent from the resource when its access is complete. In FIG. 33 there is depicted the correspondence between the address space of the MCU 33 and the HDC-controlled resources.

A time division access contention for the sector buffer is controlled by the sector buffer control circuit 34f. There are such accessing objects as listed below.

A1: Disk media user data transfer

A2: DRAM refresh

B1: Host user data transfer

B2: Host command parameter transfer

C1: ECC ON THE FLY Data correcting sequencer process

C2: Disk media NO-ID Reference to sequencer table

C3: MCU program data transfer

S1: No-ID Sequencer table generation

In the group of three accessing objects A, B and C, they are serviced on a fixed-priority basis. In each group the priority decreases in ascending order of numbers. When no request is made in the group, the service for the group is skipped. A1 and B1 are user data transfer processes and require wide transfer bands. The refresh process (A2) needs to be carried out a prescribed number of times within a prescribed time to meet the specifications of the DRAM. To avoid a decrease in the media data transfer band, the refresh process is not performed during data transfer but the specifications are satisfied by performing it intensively in the period during which although the media processing is carried out but the head is one a servo pattern or the like and no actual data transfer is not effected. The other processes are carried out at fixed time intervals.

The host command parameter transfer (B2) is conducted to preserve command data bytes (CDB) that is used in SCSI. In QUEUE processing in which the next command is sent before completion of the previous command, this transfer scheme is used; for example, to reorder many commands stored in a table on the sector buffer.

The ECC data correction process (C1) is carried out in units of data called a sector that is usually 512-byte long. When one sector contains a lot of data to be corrected, high-speed processing is needed, and hence a hardware sequencer is employed. With a view to reducing the processing time, read from the sector buffer, correction and write are conducted in one service.

The disk media NO-ID process (C2) removes IF information conventionally added to the beginning of user data on media and manages the data on a memory so as to enhance the efficiency of utilization of the media. This process is also carried out using a hardware sequencer. During media data processing the ID table on the sector buffer is accessed several words for each sector. When the head movement processes areas of different media data densities, the ID information table needs to be regenerated (S1). A hardware sequencer dung head movement also performs this processing. Since the processes S1 and A1 collide with each other, contention control is effected in the groups of A2, B1, Cn and S1 only during this processing.

The MCU program data transfer (C3) has the lowest priority in the group C, but since the processes (C1) and (C2) are so low in frequency that the process (C3) is almost always performed. FIG. 34 depicts how the processes A1, B1 and C1 are performed when the MCU makes a four-word access.

In case of write, if the ring FIFO 34d is made four-word, it is possible to receive all data from the MCU 33 (i.e. to perform cache processing). But if the signal ACK is sent to the MCU 33 prior to completion of resource access, processing of the MCU 33 proceeds and issues the next request, which makes the processing at the HDC 34 side complicated. To avoid this, the signal ACK corresponding to the fourth word is sent upon completion of the resource access.

When the MCU 33 makes one-word access as in the prior art, the time of one cycle period of each of the processes A1, B and C1 is 650 ns and the transfer rate of the MCU 33 is approximately 3.1 MB/s on the average. The afore-mentioned four-word access causes an increase of only 75 ns and permits processing of data four times more than in the past with no practical influence of the transfer of the host media and an average transfer rate of 11.0 MB/s can be achieved.

The page mode access to the DRAM can be processed at high speed within the same page, but there is a possibility that access from the MCU 33 is set spanning adjacent pages. In the case where the four-word access in the process C3 spans across the page boundary while the processes A2 and C3 are carried out, the access is made in such a manner as depicted in FIG. 35.

Since the page changes, the access to the third word requires regeneration of the signal RAS, but the HDC 34 does not accept other sector buffer access requests and continues MCU processing.

The DRAM refresh processing is performed intensively with a period shorter than the 15.625-s intervals (512 times/4 ms) (the DRAM specifications) during the servo pattern processing or the like as described previously. This eliminates refresh processing during the media data transfer to ensure maintaining the required user data transfer band.

While the MCU 33 and the HDC 34 have been described to be provided as independent ICs in Embodiment 4, they may also be integrated into one IC, in which case the effects mentioned below can be expected.

To begin with, the HDC control by the feedback thereto of the clock becomes unnecessary. Further, the MCU address signal line, data output line and data input line are set independently, so that the address output and the data input/output can be made concurrent. In consequence, the access time is reduced also because of overlapping of the request state and the response state. The time for signal collision avoidance, which accompanies the switching of the direction of transfer in the read operation of the MCU, also becomes unnecessary. Besides, no signal delay by the input/output circuit connected to the outside of the IC is caused and a 50-ns cycle time can be reduced.

It is to be understood that the above-described preferred embodiments of the present invention are merely illustrative of the invention, not in limiting sense, and that many modifications and variations may be effected without departing from the spirits and scope of the claims appended hereto.

What is claimed is:

1. A data access unit including a hard disk controller and a microcomputer unit connected to said hard disk controller, said data access unit comprising:
clock synchronizing means for operating said hard disk controller and said microcomputer unit in synchronization with a clock signal; and
control means whereby plural data input/output operations between said hard disk controller and said microcomputer unit, based on a single-access request command issued from a CPU of the latter, are each performed continuously, discretely, or in a combination thereof for an arbitrary access time according to a response status created in accordance with the access condition of a resource managed by said hard disk controller.

2. The data access unit according to claim 1, wherein said microcomputer unit transmits to said hard disc controller access command information such as a data access address, a write identification signal indicating whether said microcomputer unit is to read or write a data from or to the data access address, and an access number signal indicating the amount of data to be transferred at one time, and wherein said hard disc controller issues a request for access to its managing resource based on the access command information transmitted from said microcomputer unit.

3. A data access unit comprising:
a microcomputer unit transmitting a data access mode designating signal and a data access address;
receive means for receiving the data access mode designating signal and the data access address transmitted from said microcomputer;
recognize means for recognizing a data access mode based on the data access mode designating signal received by said receive means;
data access means for accessing the data access address received by said receiving means; and
send means for sending to said microcomputer an acknowledge signal indicating the end of data accessing of said data access means when said data access means has completed the accessing of the data access address, and for transmitting a data to or from said microcomputer from or to the data access address in the data access mode recognized by said recognize means.

4. The data access unit according to claim 3, wherein the data access mode is one of a normal access mode and a continues access mode.

5. The data access unit according to claim 3, wherein the data access address is data read address, and said data access means access to the data access address to read a data stored in the data read address.

6. The data access unit according to claim 3, wherein the data access address is data write address, and said data access means access to the data access address to write a data to the data write address.

7. The data access unit according to claim 3, wherein some of the data access mode designating signal, the data access address and the data to be transmitted are transmitted via a common bus in a manner of time-sharing.

8. The data access unit according to claim 3, wherein the data access address is an address in one of a DRAM, ROM or a peripheral device.

9. The data access unit according to claim 8, wherein said peripheral device is a hard disc, and said receive means, said recognize means, said data access means and said send means comprise a hard disc controller.

10. A data access method comprising the steps of:
actuating a disk media controller and a microcomputer connected thereto in synchronization with a clock; and
when a CPU of said microcomputer issues a single-access request command, performing each data input/output operation, based on said command, between said microcomputer and said controller continuously, discretely, or in a combination thereof for an arbitrary access time according to a response status created in accordance with the access condition of a resource managed by said controller.
